(19) United States
(12) Patent Application Publication
(10) Pub. No.: US 2026/0269586 A1
(43) Pub. Date: Sep. 10, 2026

(54) ENCLOSURE WITH PRESS-ON LID

(71) Applicant: Easy Solar Products, Inc., Sandy, UT (US)

(72) Inventors: Graham Miller, Midvale, UT (US); Benjamin Wade, Holladay, UT (US); Alexander Bornemann, Duxbury, VT (US); Ben Kadmon, Salt Lake City, UT (US); Brady Hoddinott, New Hartford, CT (US); Paul Cruz, South Holladay, UT (US)

(73) Assignee: Easy Solar Products, Inc., Sandy, UT (US)

(21) Appl. No.: 19/558,194

(22) Filed: Mar. 5, 2026

Related U.S. Application Data
(60) Provisional application No. 63/910,951, filed on Nov. 4, 2025.
(60) Provisional application No. 63/767,731, filed on Mar. 6, 2025.

(51) Int. Cl. H02G 3/14; H02G 3/08

(52) U.S. Cl. CPC H02G 3/14; H02G 3/088

(57) ABSTRACT

An electrical junction box or other enclosure includes a base, a lid, and fasteners that permit the enclosure to be closed by manual force and opened using a tool such as a screwdriver or blade. The base includes a bottom wall and side walls defining an interior region for housing electrical or other components. The fasteners extend from or through the lid into a channel formed in the side walls of the base. A flexible member deflects as the fastener is advanced past a rigid member when fully inserted to retain the fastener in the channel and to apply a compressive force between the base and the lid. Rotation of the fastener with a tool aligns the flexible member with a gap in the rigid member, allowing the fastener to be withdrawn and the enclosure to be opened.

### CROSS REFERENCE TO RELATED APPLICATIONS

This application claims priority to and the benefit of United States Provisional Application Serial No. 63/767,731 filed on March 6, 2025, which is incorporated herein by reference in its entirety. This application also claims priority to and the benefit of United States Provisional Application Serial No. 63/910,951 filed on November 04, 2025, which is also incorporated herein by reference in its entirety.

### TECHNICAL FIELD

The following generally relates to junction boxes. It also generally relates to junction boxes and other enclosures (herein after interchangeably referred to as boxes, junction boxes, or enclosures) having snap-on or press-on lids that may utilize a tool for lid removal. The concepts set forth herein may be expanded to any sort of box or other enclosure that would benefit from a lid that can be manually connected without requiring a tool and removed using a tool.

### BACKGROUND

Junction boxes are designed to be water and contaminant proof, such that water or other contaminants are prevented from entering the interior of a box and interfering with components residing inside. Additionally, junction boxes should be designed to make it easy for a technician to attach and remove their lid.

Many types of enclosures are subject to electrical codes, underwriting requirements and/or other restrictions that specifically require the use of a tool to open the box. Tool requirements are intended to enhance safety by preventing accidental opening of the box or opening by casual users that do not have immediate access to an opening tool. The tool requirement, however, can be inconvenient, especially during initial installation of the enclosure. The tool requirement is especially inconvenient when the enclosure mounted on a roof or in another location requiring the use of a ladder for access, and/or in other similarly inconvenient locations.

### SUMMARY

There is, therefore, a need for a junction box or other enclosure that is designed for convenient and effective closure as well as safe and secure opening.

Various example embodiments are described herein. In one example embodiment, an enclosure suitably comprises a base, a lid and a fastening system. The base suitably comprises a bottom wall and side walls configured to form an interior region of the enclosure, and the fastening system suitably comprises a first fastener associated with the base and a second fastener associated with the lid. The fastening system is suitably configured to allow the base and lid to be securely coupled together through a snap-fit or push-on manual interaction, and the base and lid to be separated from each other using a tool that unlocks the first fastener from the second fastener.

In another example embodiment, the previous enclosure comprises a drill zone defined in a side wall, the drill zone having a uniform wall thickness.

In another example embodiment, the second fastener of any of the previous embodiments may be a fastening device that passes through an opening in the lid, and the first fastener comprises one or more channels configured to receive the second fastener.

In another example embodiment, the second fastener of any of the previous example embodiments may comprise a tool interaction point configured to allow a tool to rotate the second fastener such that is moves from a locked to an unlocked position allowing the lid to separate from the base.

In another example embodiment, the second fastener of any of the previous example embodiments may comprise a plurality of flexible legs that are configured to be deformable within the first fastener in response to the second fastener being inserted into first fastener.

In another example embodiment, any of the previous example embodiments may further comprise a third fastener associated with an opposite end of the base than an end that interacts with the second fastener, wherein during a first time period, the first fastener is removably attached to the second fastener, and wherein during a second time period the second fastener is removably attached to the third fastener.

In another example embodiment, any of the previous example embodiments could further comprise a hinge system configured to be coupled to the lid and the base and to allow a hinging operation between the lid and the base, wherein the hinge system is coupled to a first portion of the lid and the base, and wherein the fastening system is coupled to a second, separate portion of the lid and the base.

In another example embodiment, an enclosure suitably comprises a base, a lid, and a fastener. The base suitably comprises a bottom wall and a plurality of side walls extending substantially perpendicular from the bottom wall to form an interior region of the enclosure, wherein one or more of the side walls has a channel formed therein, the channel having a rigid member. The lid has a lower surface configured to interact with the side walls of the base. The fastener is configured to extend from or through the lower surface of the lid into the channel, the fastener comprising a head and a flexible member, and the flexible member is configured to flex in response to the fastener being advanced into the channel and to engage the rigid member in response to the fastener being fully advanced in the channel to retain the fastener in the channel and to apply a compressive force between the base and the lid.

In another example embodiment, any of the foregoing example embodiments could include fasteners that are each rotatable in response to application of a tool so that the flexible member in the channel aligns with and passes through a gap in the rigid member, thereby permitting the fastener to be removed from the channel.

In another example embodiment, any of the foregoing examples could implement the flexible member with a pair of flexible legs.

In another example embodiment, any of the foregoing examples could implement the lid to apply a compressive force to the base in response to engaging the rigid member, and wherein the does not apply a compressive force to the base when installed to the base adjacent the bottom wall.

In another example embodiment, any of the foregoing examples include a formed-in-place (FIP) gasket disposed at an interface between the side walls of the base and the lower surface of the lid.

In another example embodiment, any of the foregoing examples could implement the at least one of the side walls of the base and the lower surface of the lid to comprise a circumferential ridge that is configured to receive the FIP gasket and to apply pressure against the FIP gasket when the compressive force is applied.

In another example embodiment, any of the foregoing examples could include a drill zone located in one or more of the plurality of sidewalls and comprising a thickness that is substantially constant across the drill zone.

In another example embodiment, the previous example embodiment could implement the base to comprise molded polycarbonate material, and the substantially constant thickness is between about 0.1 and about 0.2 inches.

In another example embodiment, any of the foregoing examples could include the channel to extend from a top of the one or more sidewall though a bottom wall of the base and to be configured to receive the fastener at the bottom wall of the base to releasably couple the lid to the bottom wall of the base.

In another embodiment, a method suitably includes the functions of: inserting a fastener extending from or through a lid into a channel of a base of an enclosure; flexing a flexible member of the fastener for a predetermined distance within the channel before the flexible member moves back into a static position to allow snapping of the flexible member against a rigid member of the channel; applying a compressive force between the lid and the base based on the snapping; and rotating the fastener a predetermine distance to enable releasing of the fastener from the channel.

In another example embodiment, the method of the preceding example further comprises receiving a gasket in a circumferential ridge in the lid and/or the base; and applying pressure against the gasket based on the compressive force.

In another example embodiment according to any of the preceding methods, during a first time period the lid is attached to the top of the base; and during a second time period the lid is attached to the bottom of the base.

In another example embodiment, any of the preceding embodiments could further comprise after the fastener is in the predetermined position, rotating the fastener from a first position to a second position to increase the compressive force between the lid and the base.

In several of the foregoing examples, the flexible member is described as being attached to or a portion of the fastener, and the rigid member is attached to or a portion of the channel of the base. Equivalent structures could implement the flexible member as attached to or a portion of the channel, and the rigid member as attached to or a portion of the fastener. Still other equivalent embodiments could interchange the functions of the flexible and rigid members such that either or both are implemented on either or both of the fastener and/or the channel of the base.

Additional embodiments provide other enclosure devices, systems, methods and/or processes substantially as described herein, and/or their legal equivalents.

### DESCRIPTION OF THE DRAWING FIGURES

The following discussion is provided with reference to various drawing figures. The drawing figures referenced below illustrate various views of example embodiments of one or more junction boxes for consistency, although other embodiments will vary from the specific embodiments illustrated here.

FIG. 1 is a perspective view of an enclosure according to some embodiments.

FIG. 2 is an exploded perspective view of an enclosure according to some embodiments.

FIGS. 3A, 3B, 3C, and 3D, illustrate an end, perspective, first side, and second side view of a fastener according to some embodiments.

FIG. 4 is an exploded view of an enclosure according to some embodiments.

FIGS. 5A, 5B, and 5C are cross-sectional view along line A-A, cross-section view along line B-B, and top views showing lines A-A and B-B of an enclosure according to some embodiments.

FIG. 6A is a cross-sectional view of a lid and enclosure along line D-D of (bottom) side view a lid on a top of an enclosure showing line D-D according to some embodiments.

FIG. 6B is an exploded, perspective view of a lid spaced from a bottom of an enclosure according to some embodiments.

FIG. 6C is (top left) a side view of an enclosure, (top right) zoomed view of a portion of the enclosure, (bottom left) bottom view of a lid, and (bottom right) zoomed in view of a portion of the lid according to some embodiments.

FIG. 6D is (left) exploded view of a lid and enclosure, (top right) side view of a lid and enclosure, and (bottom right) portion of the lit and enclosure according to some embodiments.

FIG. 6E is (top left) a top view of a lid, (bottom left) side view of a lid showing line D-D, and (bottom right) cross-section view of a lid along line D-D according to some embodiments.

FIG. 6F is (top left) a top view of a lid, (middle left) side view of a lid, (bottom left) bottom view of a lid, and (right) cross-sectional view of a lid according to some embodiments.

FIG. 7 is an exploded perspective view of an enclosure according to some embodiments.

FIGS. 8A, 8B, 8C, and 8D, illustrate an end, perspective, first side, and second side view of a fastener according to some embodiments.

FIG. 9A is a top view of an example enclosure according to some embodiments. FIG. 9B illustrates a cross-section along line A-A of FIG. 9A, and FIG. 9C illustrates a cross-section along line B-B of FIG. 9A according to some embodiments.

FIG. 10A is a top view of an example base according to some embodiments. FIG. 10B is a cross-sectional view along line C-C of FIG. 10A, and FIG. 10C is a detailed view of area according to some embodiments.

FIG. 11 is an exploded perspective view of an enclosure according to some embodiments.

FIG. 12A is a top view of an example base according to some embodiments. FIG. 12B is a cross-section view along line B-B of FIG. 12A according to some embodiments.

FIG. 13A is a top view of an example enclosure according to some embodiments. FIG. 13B is a cross-section view along line B-B of FIG. 13A according to some embodiments.

FIG. 14 is a perspective view of an enclosure and lid according to some embodiments.

FIG. 15 is an exploded view of an enclosure and lid according to some embodiments.

FIG. 16A is a top view of an example enclosure according to some embodiments. FIG. 16B is a cross-sectional view along line B-B of FIG. 16A according to some embodiments.

FIG. 17A is a top view of a lid according to some embodiments. FIG. 17B is a cross-sectional view along line C-C of FIG. 17A according to some embodiments.

FIG. 18 is a perspective view of an enclosure having a closed lid according to some embodiments.

FIGS. 19-20 are perspective views of an enclosure having an open, hinged lid according to some embodiments.

FIGS. 21-22 are exploded views of an enclosure according to some embodiments.

FIG. 23 is a perspective view of an enclosure and lid according to some embodiments.

FIGS. 24-25 are perspective views of an enclosure and lid in an open position according to some embodiments.

FIGS. 26-27 are exploded views of an enclosure according to some embodiments.

FIGS. 28-29 are perspective views of an enclosure and lid in an open position according to some embodiments.

FIGS. 30-31 are perspective views of an enclosure and lid according to some embodiments.

FIGS. 32A and 32B show open and closed views of a hinged enclosure and lid according to some embodiments.

FIG. 33 is a side view of an enclosure and hinged lid according to some embodiments.

FIGS. 34 and 35 are perspective views of an enclosure and hinged lid in closed positions according to some embodiments.

FIGS. 36 and 37 are perspective views of an enclosure and hinged lid in open positions according to some embodiments.

FIG. 38A is a top view of an example enclosure according to some embodiments. FIG. 38B is a cross-sectional view along line A-A of FIG. 38A according to some embodiments.

FIGS. 39A and 39B are side and perspective views, respectively, of fasteners according to some embodiments.

FIG. 40A is a top view of a base according to some embodiments. FIG. 40B is a cross-sectional view along line A-A of FIG. 40A, and FIG. 40C is a detailed view of area B in FIG. 40B according to some embodiments.

FIG. 41A and 41B are top and front views, respectively, of an enclosure according to some embodiments. FIG. 41C is a cross-sectional view along line A-A of FIG. 41A according to some embodiments.

FIGS. 42A and 42B are top and front views, respectively, of an enclosure according to some embodiments. FIG. 42C is a cross-sectional view along line C-C of FIG. 42A according to some embodiments.

FIGS. 43A is a side view of an enclosure according to some embodiments. FIG. 43B is a cross-sectional view along line A-A of FIG. 43A according to some embodiments.

FIGS. 44A is a side view of an enclosure according to some embodiments. FIG. 44B is a cross-sectional view along line B-B of FIG. 44A according to some embodiments. 44C is a detailed view of area C in FIG. 44B.

FIGS. 45A and 45B are bottom and top views, respectively, of enclosures according to some embodiments. FIG. 45C is a detailed view of area D of FIG. 45B. FIG. 45D is a detailed view of area C in FIG. 45E, and FIG. 45E is a cross-section view along line A-A of FIG. 45B according to some embodiments.

FIGS. 46A and 46B are bottom and top views, respectively, of enclosures according to some embodiments. FIG. 46C is a detailed view of area E of FIG. 46B. FIG. 46D is a detailed view of area F in FIG. 46E, and FIG. 46E is a cross-section view along line B-B of FIG. 46B according to some embodiments.

FIGS. 47A, 47B, 47C, and 47D, are top, perspective, and two different side views of an enclosure according to some embodiments.

The various drawing figures provide alternate views of example enclosure designs, with reference signs being consistent throughout the various drawings.

### DETAILED DESCRIPTION

The following disclosure provides many different embodiments, or examples, for implementing features of the provided subject matter. Specific examples of components and arrangements are as described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not dictate a relationship between the various embodiments and/or configurations discussed. It is noted that, in accordance with the standard practice in the industry, features are not drawn to scale. In fact, the dimensions of the features may be arbitrarily increased or reduced for clarity of discussion. The following disclosure may include the terms “about” or “substantially” to indicate the value of a given quantity can vary based on a particular technology. Based on the technology, the term “about” or “substantially” can indicate a value of a given quantity that varies within, for example, 1–15% of the value (e.g., ±1%, ±2%, ±5%, ±10%, or ±15% of the value).

According to various embodiments, a junction box or other enclosure comprises a push-on or snap-type components that permit a lid to be attached to a base of the enclosure through manual user action and may not use a tool. In some aspects, when compliance dictates, removal of the lid can be performed with a flat or shaped edge device, for example a screwdriver, knife or other tool to preserve safety and to comply with any applicable design or certification requirements.

Throughout this disclosure, although enclosure 100 or similar enclosures are illustrated approximately square in shape, other embodiments may exhibit round, triangular, parallelogram, pentagonal and/or any other shapes, as desired.

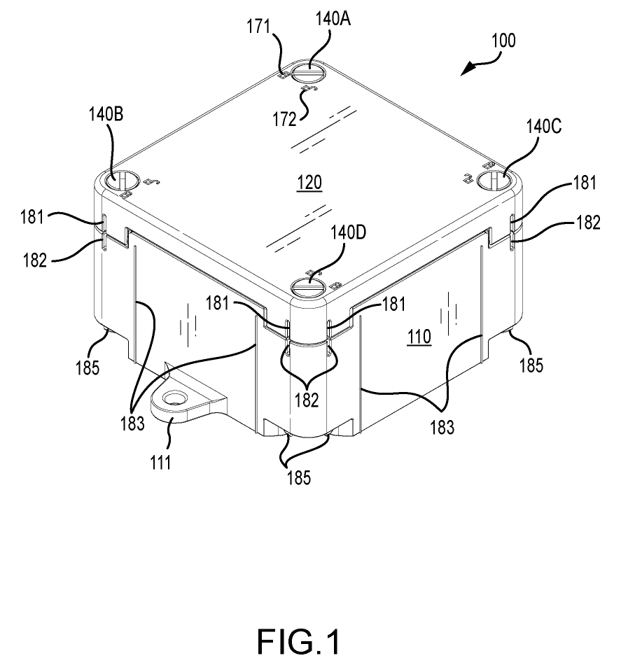

FIG. 1 is an enclosure 100, according to some embodiments. For example, enclosure 100 comprises a base 110 and a lid 120. In this example, lid 120 is attached to base 110 using an appropriate number of fasteners 140 (e.g., 140A, 140B, 140C, and 140D) that extend through lid 120 into base 110. In some aspects, each fastener 140 is rotatable within its position in lid 120 between a locked position 171 and an unlocked position 172.

It is to be appreciated that while in this configuration fasteners extend through lid 120 into base 110, fasteners can be used that extend from and are unitary or integral with lid 120 into base 110 and/or from base 110 into lid 120. In some aspects, openings are formed in the lid or base that allow a tool to be inserted into the opening to interact with the fastener in a way that allows release of the fastener from base 110 or lid 120, allowing for releasably and securely closing or opening of the enclosure 100. In an aspect, an interaction of the tool and the fastener is analogous to a locked and unlocked position.

In some aspects, lid 120 and base 110 are sized and shaped for secure connection to protect electrical connections or other components within the interior of enclosure 100.

In some aspects, an attachment tab 111 with a hole can be used to attach enclosure 100 to a roof, floor, wall or other surface using one or more screws, bolts or other attachment hardware as appropriate. It is to be appreciated while one attachment tab 111 is shown, a second attachment tab 111 may be included that is hidden from view on the opposite side of enclosure 100). In some aspects, any number of attachment tabs 111 having any number of holes or other features. In some aspects, attachment tabs 111 may be located at any other positions and/or shaped in any other manner to accommodate attachment of enclosure 100 to any appropriate surface(s) using any desired hardware. Still other embodiments could eliminate attachment tabs 111, if desired.

In various embodiments, base 110 and lid 120 may be injection molded or otherwise formed from composite material such as fiberglass reinforced polyester (FRP), glass reinforced plastic (GRP), carbon fiber reinforced polymer (CFRP), polycarbonate (PC) composites, glass-filled nylon, thermoset polyester composites, dough molding compound (DMC), bulk molding compound (BMC) and/or the like. Other materials (including materials that are subsequently derived from the materials listed or otherwise subsequently developed) could also be used.

In some aspects, enclosures made from polymer or other composite material may be used instead of metal. In some aspects, enclosures that are injection molded or otherwise formed from modern materials can exhibit performance and durability characteristics that are more desirable than metal. The injection molding process may allow for additional features to be added to the enclosures, and for broad customization for particular implementations or settings. Injection molding may also allow for incorporation of new features for assembly and installation, resistance to moisture or other contaminants, and/or improved performance.

In some aspects, slots 181 are formed in lid 120, slots 182 are formed in base 110, and drill zone indicators 183 are formed on the sidewalls of base 110. These features are described in increasing detail below.

In some aspects, male press-fit features 185 are provided for attaching lid 120 to a bottom of base 110 prior to installation. These features are also described in increasing detail below.

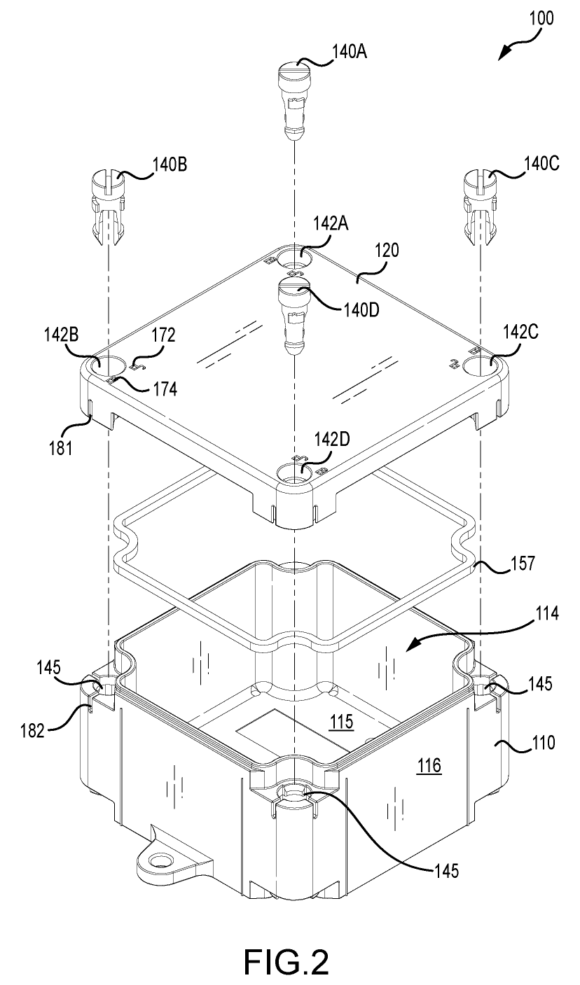

FIG. 2 is an exploded view of enclosure 100 according to some embodiments. In some aspects, lid 120 is secured to base 110 using four fasteners 140A-140D. In this example, an optional gasket 157 (e.g., a form-in-place (FIP) gasket) is illustrated to provide a tighter seal between lid 120 and base 110 when lid 120 is secured to close enclosure 100.

In some aspects, base 110 includes a substantially planar surface 115 from which one or more sidewalls 116 extend in a substantially parallel (e.g., vertical) direction to form an interior 114 that is further enclosed by lid 120. In some aspects, an outer surface of the one or more sidewalls 116 are substantially flat.

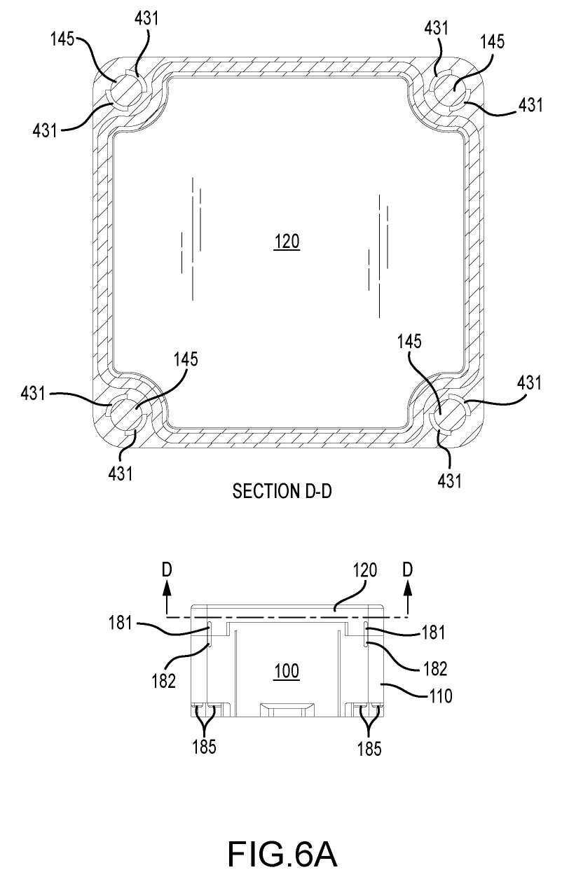

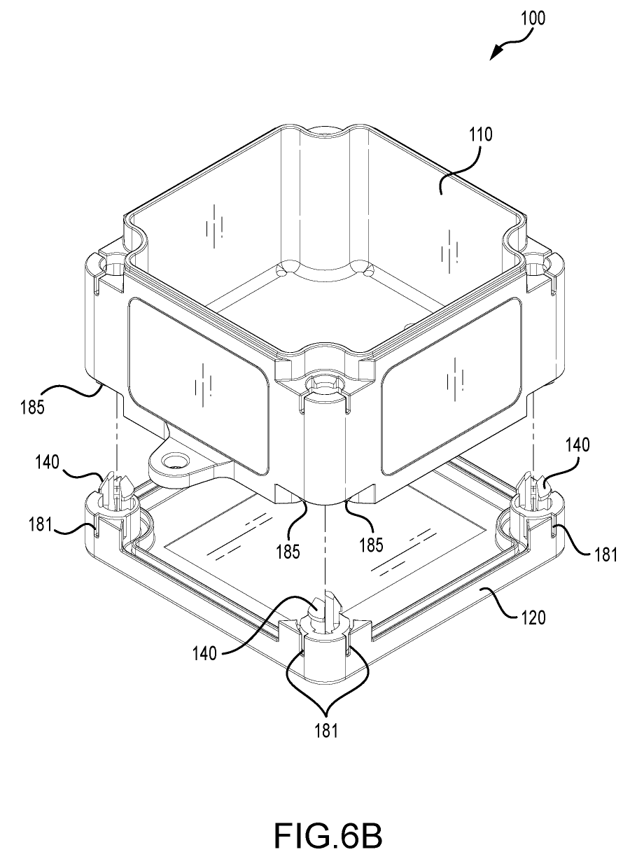

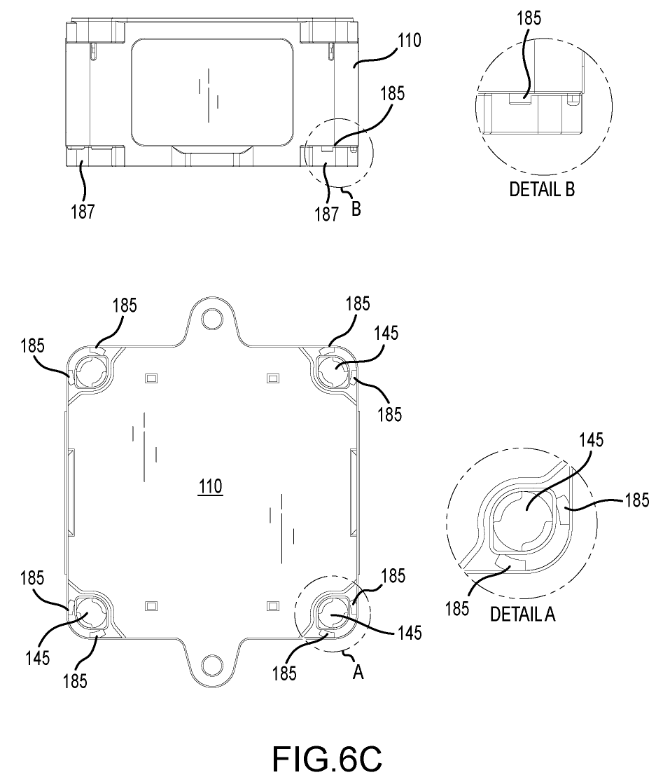

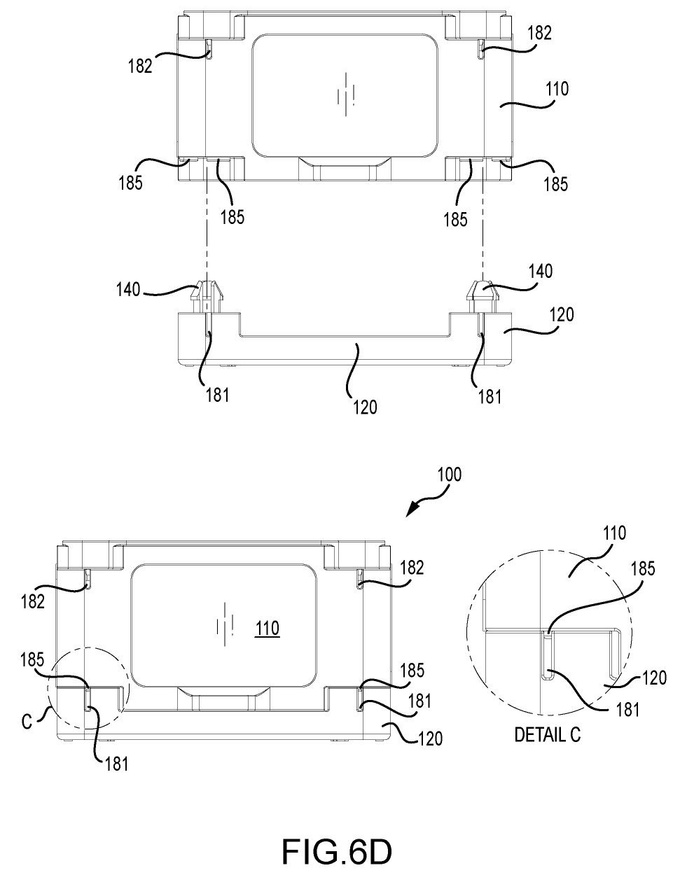

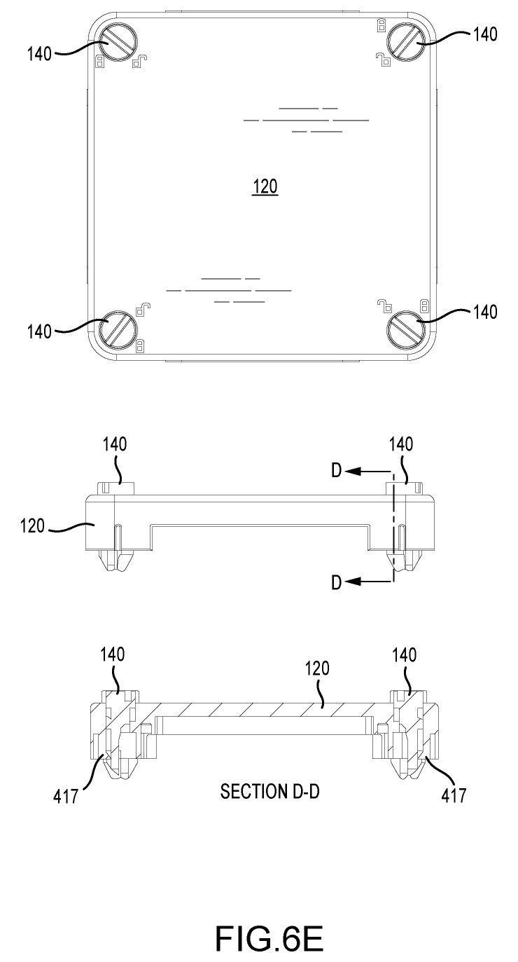

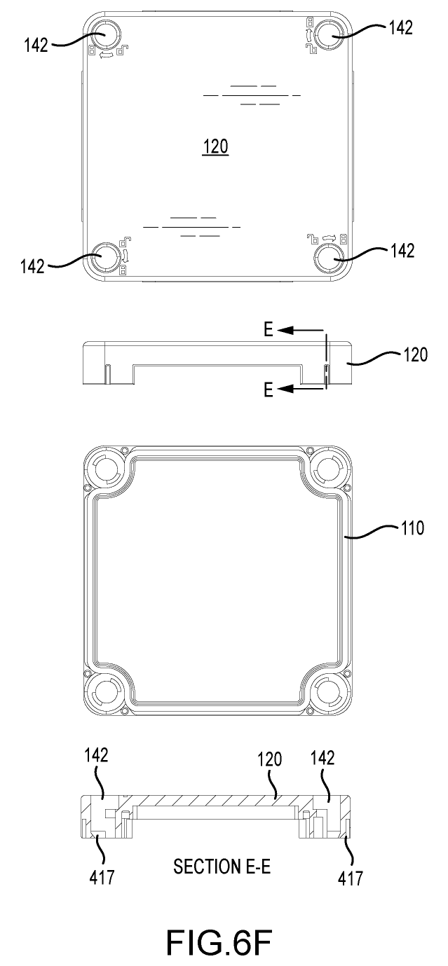

In some aspects, fasteners 140A-140D passing through holes 142A-142D in lid 120 and are received in channels 145A-145D in base 110, respectively, to retain lid 120 in position against an upper surface of sidewalls 116. In some aspects, fasteners 140A-140D may be inserted into holes 142A-142D in lid 120 after manufacture of the individual parts and before distribution of the usable product to end users. For example, as seen in FIG. 6B, lid 100 with fasteners 140A-140D can be attached to a bottom of base 110 during distribution.

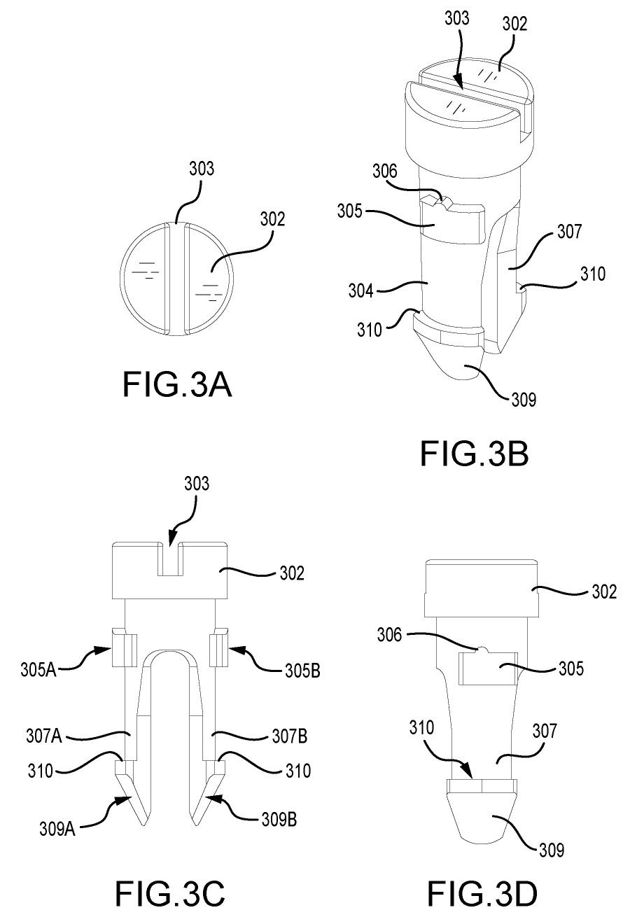

FIGS. 3A, 3B, 3C, and 3D illustrate an end, perspective, first side, and second side view of a fastener 140 according to some embodiments. In some aspects, fastener 140 is formed with a head 302 having a slot 303. Slot 303 may be shaped to receive a screwdriver (e.g., a straight blade or Phillips head screwdriver) or similar tool. Equivalent embodiments could be formulated in which slot 303 is shaped for Phillips, hexagonal, Torx, and/or any other shapes, including any proprietary shape if desired. Slot 303 may permit an appropriate tool to apply an appropriate force or torque to move fastener 140 between locked position 171 and unlocked position 172.

In some aspects, fasteners 140 include two flexible legs 307 that deform to permit insertion and retention of fastener 140 within lid 120 and base 110. In some aspects, fasteners 140 may be fashioned of plastic, composite, other molded material, or any like material having a density, rigidity and/or thickness to permit legs 307 to flex inwardly toward each other while still maintaining axial pressure on channel 145. Although two legs 307 are shown, other embodiments could use a single flexible leg (e.g., along with a rigid leg for stability), or additional flexible legs 307 (e.g., three or four legs) as desired. In some aspects, fastener 140 be readily moveable between two axial positions within channel 145 to permit snap secure closing and tooled release and opening.

In some aspects, fasteners 140 are shown with one or more protrusions 305 in the form of a locking lug or the like that aids in retaining fastener 140 within channel 145 of base 110. In some aspects, two protrusions 305 are each positioned on opposite sides of fastener 140 and each occupy approximately 25% of the circumferential area of fastener 140 so that about half of the circumference of fastener 140 is covered by protrusion 305. In some aspects, protrusions 305 can be rotated using the tool in slot 303 to align or dis-align with protrusions in the channels 145 of base 110, thereby permitting fastener 140 to be inserted or removed from channel 145 as desired.

In some aspects, protrusions 305 also include an interference feature 306 that applies additional downward pressure to protrusions 305 in base 110 to maintain a secure fit between lid 120 and base 110. In some aspects, interference features 306 can be differently shaped or omitted entirely and/or additional features 306 could be provided.

In some aspects, fastener 140 has two flexible legs 307 each terminating in a tapered portion with tapered edges 309. The flexibility, which results from the thickness of legs 307, permits legs 307 to deform when fastener 140 is inserted past protrusions in channels 145 of base 110 to thereby permit fastener 140 to advance in channel 145. Tapered portion 309 on the front end (e.g., the end first inserted into channel 145) encourages legs 307 to deform as the front end encounters protrusions in channel 145. After fastener 140 is fully inserted into channel 145, ledges 310 or similar flattened portions of each leg 307 engage the bottom of the base protrusions and to thereby maintain fastener 140 in fixed position within channel 145 of base 110. In the illustrated example, legs 307 deform toward the center of channel 145 (i.e., towards each other), although other embodiments could permit legs 307 to deform or flex in any other manner. In some aspects, legs 307 flex past each other or deform outwardly to create the snap feature.

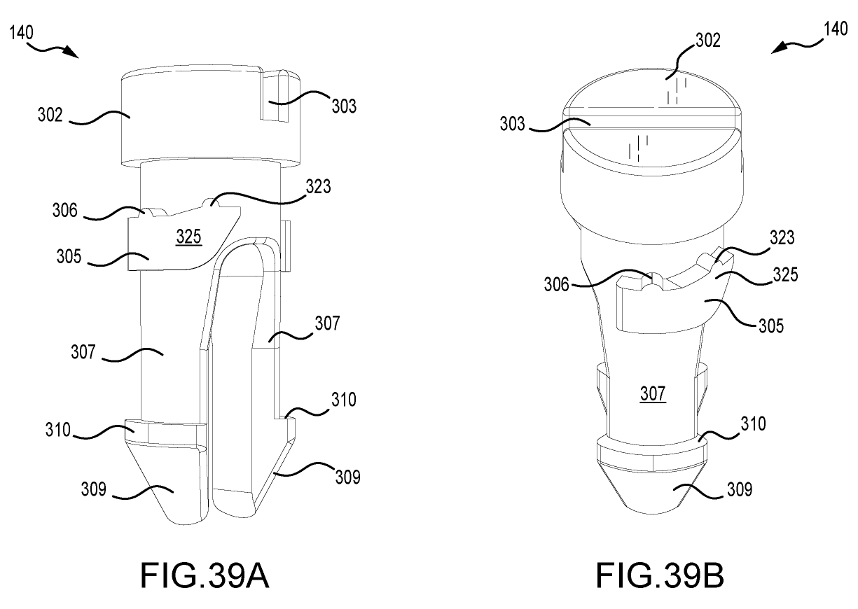

As described more fully below (see, e.g., FIGS. 39A-B), if additional pressure is desired between base 110 and lid 120 (e.g., for an increased NEMA rating), protrusions 305 may be modified to include a more wedge-shaped portion and/or one or more additional protrusions 305 maybe added to the wedge-shaped portion. In another embodiment, for an increased NEMA rating, fastener 140 can be rotated to two quarter turn locations within channel 145 to provide additional pressure between base 110 and lid 120.

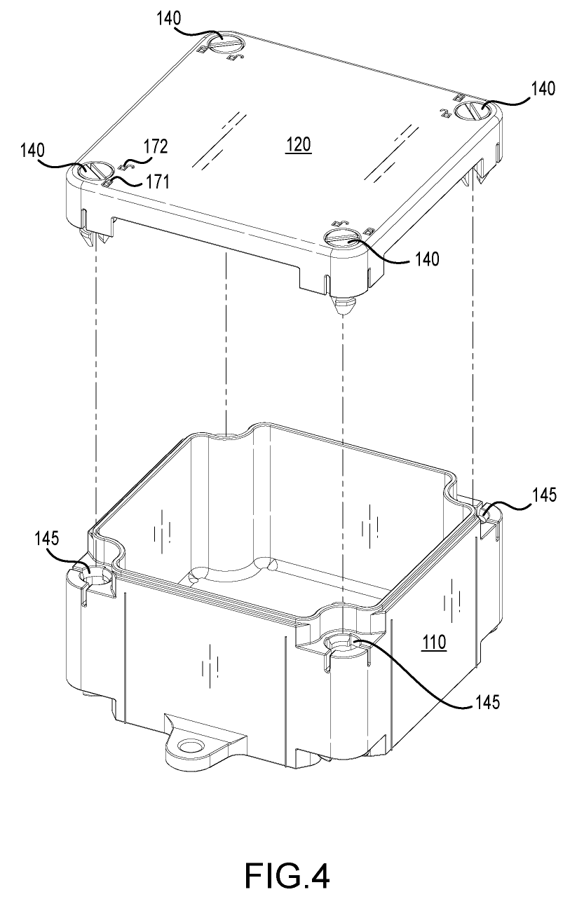

FIG. 4 is an exploded view of an enclosure 100 according to some embodiments. In some aspects, four fasteners 140A-140D can be pre-installed into lid 120, thereby allowing lid 120 to be pressed onto the base 110 for assembly without the use of a tool. In some aspects, fasteners 140 are initially positioned so that slot 303 is aligned in locked position 171 so that the protruding sections 305 and 310 of fasteners 140 are aligned for insertion past any protrusions in channels 145 in base 110.

In some aspects, after lid 120 is snapped into position with fasteners 140 fully inserted into channels 145, lid 120 cannot be removed unless fasteners 140 are rotated into the unlocked position 172 using a tool.

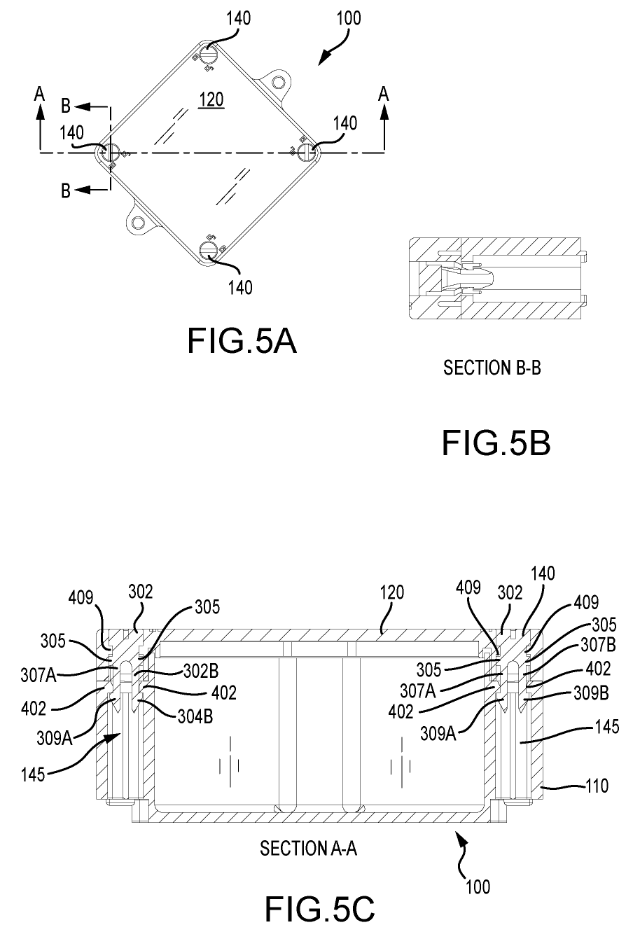

FIGS. 5A, 5B, and 52C, are cross-sectional view along line A-A, cross-section view along line B-B, and top views showing lines A-A and B-B of an enclosure 100 according to some embodiments. For example, these figures show additional detail of the interior of base 110 and lid 120 when fasteners 140 are in position within channels 145. In some aspects, hole 142 of lid 120 includes a protrusion 409 that catches head 302 of fastener 140, thereby preventing further movement of fastener 140 into channel 145. In some aspects, fasteners 140 may be pre-positioned within holes 142 of lid 120 so that heads 302 of fasteners 140 are held in place by protrusions 409.

In some aspects, to remove fasteners 140 from lid 120, a user would typically squeeze legs 307 so that they can fit though protrusions 409. In some aspects, gaps are provided in protrusions 409 so that legs 307 could be turned for removal from lid 120. In other embodiments removal of snap fasteners 140 from lid 120 may be performed in other manners.

In some aspects, each channel 145 in base 110 is also shown with a base protrusion 402 that catches ledges 310 of fasteners 140 as they are fully inserted. In some aspects, to install lid 120 against upper sidewalls 116 of base 110, an installer simply aligns fasteners 140 that are positioned in lid 120 with channels 145 of base 110, and applies a manual force.

In some aspects, tapered edges 309 of the fasteners initially encounter base protrusion 402 of channel 145, which causes protrusions 305 to deform inwardly towards each other to permit fastener 140 to advance past base protrusion 402 and snap into place with ledge 310 against protrusion 402. In some aspects fastener protrusions 305 and 309 are mated with protrusions 409 and 402, respectively, to thereby maintain a rigid connection between lid 120 and base 110. In some aspects, fasteners 140 could be alternately aligned so that protrusions 305 and 309 align with gaps between protrusions 402 and 409 to thereby permit lateral movement of fastener 140 with respect to channel 145. This may be most useful for removing lid 120 and could also permit convenient attachment of lid 120. In some aspects, it may be desirable to turn fastener 140 using a tool or the like in slot 303 to maintain a tight and rigid connection. In some aspects, a wedge-type structure could be added to one or more of protrusions 402 and/or 409 to tighten the seal between lid 120 and base 110.

In some embodiments, base protrusions 402 and 409 occupy about half of the circumference of channel 145 so that protrusions 309 and 305 of fastener 140 can be deformed into position, and then rotated to bypass protrusions 402, 409 as lid 120 is removed from base 110. That is, fastener protrusions 305 and 309 may be aligned with gaps in protrusions 409, 402 to permit removal of fastener 140. In some aspects, protrusions of channels 145 and fasteners 140 are differently shaped and/or positioned in any other manner desired.

FIG. 6A (top) is a cross-sectional view of a lid 120 and base 110 along line D-D of FIG. 6A (bottom), which is a side view of a lid 120 on a top of base 110 showing line D-D according to some embodiments. For example, this figure illustrates a lid 120 in which additional features are provided. In some aspects, quarter turn cuts 431 are provided adjacent holes 142 to permit locking or unlocking of fasteners 140. These cuts 431 may provide additional space to accommodate a screwdriver or other tool to facilitate more convenient turning of fasteners 140.

In some aspects, enclosure 100 includes drain slots 181, 182 in lid 120 and base 110, respectively, to facilitate the draining of moisture that may accumulate inside enclosure 100. In some aspects, slots 181, 182 may be of any shape and size. In some aspects, drain slots 181, 182 are located on each side of enclosure 100 so that at least one set of slots will be oriented downward whenever enclosure 100 is mounted vertically (e.g., against a sidewall of a building, pole or other structure). In some aspects, at least one set of slots 181, 182 is oriented downward to allow gravity to pull water or other contaminants out of enclosure 100. This can be beneficial in certain climates where leakage or condensation would otherwise permit even small amounts of moisture to accumulate within interior 114 of enclosure 100. In colder climates, this moisture could freeze and accumulate into an ice dam, which could in turn damage components within interior 114 of base 110. In some aspects, drain slots 181, 182 or other drainage features (e.g., weep holes or the like) could be present in any embodiment of enclosure 100. Drainage features could be shaped and sized in any manner. Drain slots 181, 182 could serve an additional purpose in providing flexibility in certain portions of base 110. In some aspects, slots 181, 182 in base 110 could permit a portion of the sidewall nearest channel 145 to deform outwardly when internal pressure is applied using a fastener 140 or the like, thereby assisting in the snap action of connecting top 120 to base 110.

In some aspects, enclosure 100 may be designed so that lid 120 is fixable to the underside of base 110 prior to installation. This provides a spatially compact form that is useful for shipping, and it prevents lid 120 from becoming separated from base 110 during storage or transportation prior to installation.

FIG. 6B is an exploded, perspective view of a lid spaced from a bottom of an enclosure according to some embodiments. FIG. 6C (top left) is a side view of an enclosure, FIG. 6C (top right) is a zoomed view of a portion of the enclosure, (bottom left) bottom view of a lid, and (bottom right) zoomed in view of a portion of the lid according to some embodiments. FIG. 6D is (left) exploded view of a lid and enclosure, FIG. 6C (top right) is a side view of a lid and enclosure, and FIG. 6C (bottom right) is portion of the lid and enclosure according to some embodiments. For example, FIGS. 6B-6D illustrate one example of an enclosure 100 in which lid 120 can be retained on the outside of the bottom of base 110. This example may be modified in any number of alternate embodiments.

It is to be appreciated that the lid retention concepts set forth herein may be applied to other embodiments (including those described below).

With reference to FIG. 6B, an example enclosure 100 suitably includes male press-fit features 185 formed on the underside of base 110 that mate with slots 181 in lid 120. In some aspects, fasteners 140 may be placed in channels 145 of lid 120 prior to shipment or installation to further provide a compact package suitable for efficient shipment and storage.

With reference to FIG. 6C, male press-fit features 185 on base 110 are molded or otherwise integrally formed with cutout regions 187 that generally mirror the cutouts on the top of the base 110 that receive fasteners 140 through holes 142 in lid 120. In this example, channels 145 are designed as through-holes that pass all the way though the structure of base 110 and end at male press-fit features 185, although other embodiments could equivalently form separate channels 145 on the top and bottom of base 110. In some aspects, fasteners 140 are releasably secured through male press-fit features 185 into channels 145 to allow lid 120 to be secured to a “bottom” of based 110 for shipping and up to the point lid 120 is releasably secured to top of base 110 as discussed above.

As shown in FIG. 6D, male press-fit features 185 in base 110 mate with the slots 181 in lid 120 when lid 120 is pressed against the underside of base 110 so that lid 120 is maintained in fixed position relative to base 110. In this example, slots 181 are also intended to align with slots 182 on the top of base 110 to form weep holes for draining moisture after installation of enclosure 100, although other embodiments could use different features for attachment and for drainage.

In some aspects, holes 142 of lid 120 are formed with an internal chamfered ledge 417 that can be used to retain snap fasteners 140 within 120 prior to installation.

FIG. 6E (top left) is a top view of a lid 120, FIG. 6E (bottom left) is a side view of a lid 120 showing line D-D, and FIG. 6E (bottom right) is cross-section view of a lid 120 along line D-D according to some embodiments. FIG. 6F (top left) is a top view of a lid 120, FIG. 6F (middle left) is a side view of a lid 120, FIG. 6F (bottom left) is bottom view of a lid 120, and FIG. 6F (right) is a cross-sectional view of a lid 120 according to some embodiments. As shown in FIG. 6E and 6F, a chamfered ledge 417 on the bottom of flexible member 412 allows the fasteners 140 to be advanced though holes 142. The legs 307 of fasteners 140 deflect as leading edge 309 of the fastener 140 encounters the chamfered ledge 417, but snap back into position after 309 is advanced beyond ledge 417, thereby engaging ledge 417 of lid 120 to ledge 310 of fastener 140. In some aspects, to remove fastener 140 from the lid 120, legs 307 can be squeezed together or otherwise deformed to permit the ledge 310 to disengage with ledge 417 for removal though hole 142. It is to be appreciated that the lid and/or fastener retention techniques described herein may be modified in any manner, and implemented in any sort of enclosures 100, including those set forth below.

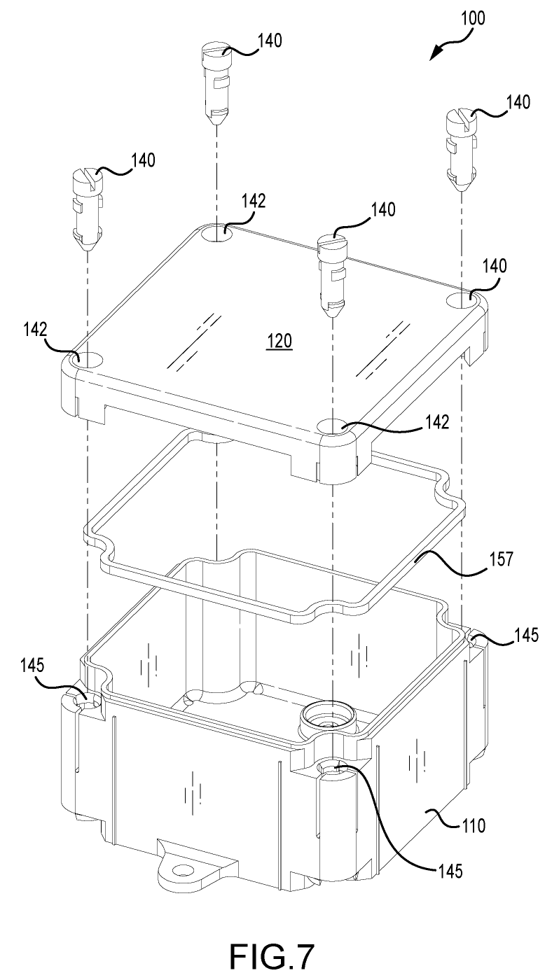

FIGS. 7-10 relate to an embodiment of enclosure 100 in which fasteners 140 are designed to be removable from top 120. This embodiment relies upon deformation of features residing inside channel 145 rather than on fastener 140, so fasteners 140 will generally be fashioned with only a single leg 307 acting as a rigid shaft that applies axial force against the deformable members of channel 145 during assembly of enclosure 100. To that end, fasteners 140 in this embodiment may be fashioned of metal, composite, hard plastic or any other suitable material, if desired.

FIG. 7 is an exploded perspective view of an enclosure 100 according to some embodiments. In some aspects, one or more fasteners 140A-140B may be inserted through holes 142 in lid 120 and into channels 145 for fixed assembly of lid 120 to base 110.

In some aspects, gasket 157 may also be provided for additional mechanical tension to further seal the connection between lid 120 and base 110.

In some aspects, gasket 157 may be formed while base 110 is being constructed by depositing or otherwise placing a layer of softer polymer resin inside base 110. In some aspects, the layer is relatively compressible and/or malleable in comparison to the more rigid polymer used to form the walls of base 110. In some aspects, a discrete gasket 157 can be formed of rubber or other compressible material is placed between lid 120 and base 110 to form a tighter seal. It is to be appreciated that gasket 157 is an optional feature that could be omitted if desired.

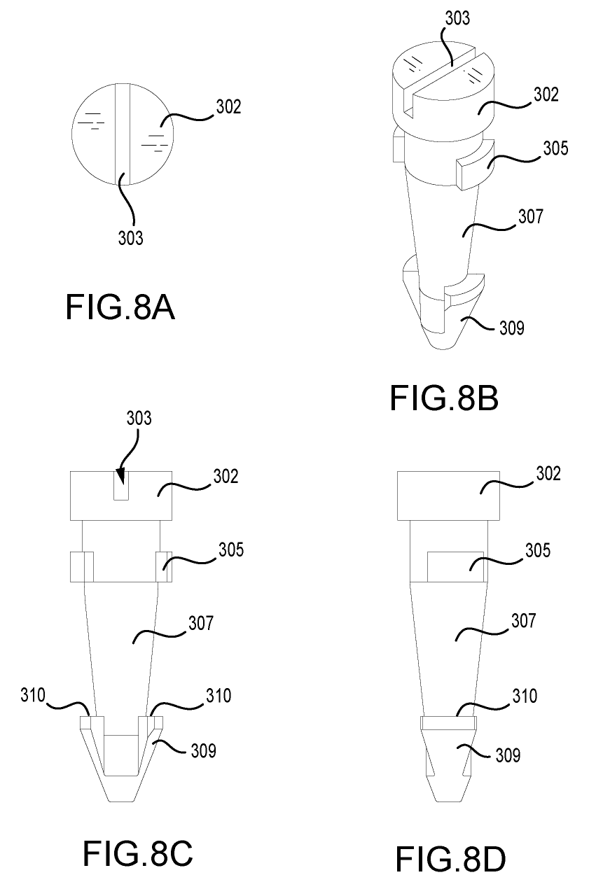

FIGS. 8A, 8B, 8C, and 8D, illustrate an end, perspective, first side, and second side view of a fastener 140 according to some embodiments. In some aspects, fasteners 140 are more rigid than the fasteners 140 discussed above. In some aspects, fasteners 140 in FIG. 8A-8D have a single leg 307, locking lugs or other protrusions 305, sloped leading edge 309, and flat ledge 310 for locking the fastener 140 into place. Protrusions 305 are shown to occupy about a quarter of the circumference of leg 307 in this example to permit removal though protrusions 409 in lid 120, although other embodiments may occupy more or less of the circumference if desired. Sloping edge 309 and ledge 310 are also shown to occupy about a quarter of the circumference that is aligned with protrusions 305, although other embodiments could arrange the features in any other manner.

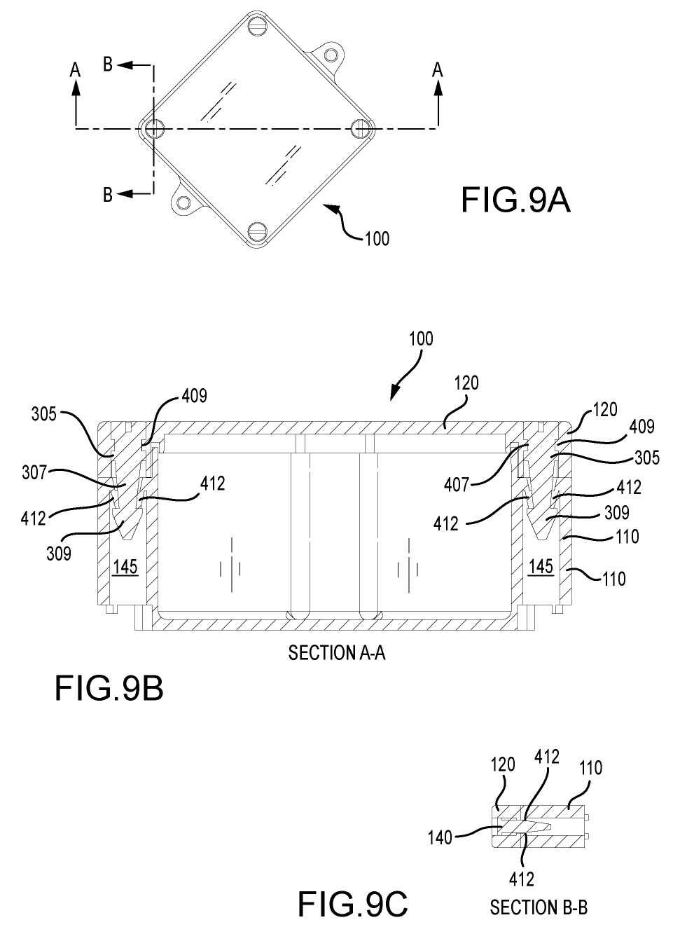

FIG. 9A is a top view of a lid showing lines A-A and B-B according to some embodiments, FIG. 9B is a cross-sectional view of an enclosure and lid along line A-A, and FIG. 9C is a cross-section view of an enclosure and lid along line B-B. In some aspects, a flexible member 412 is present within channel 145 to snap against fastener 140 when lid 120 is installed to base 110. Similar to the embodiment described above, fastener 140 advances in channel 145 due to manual pressure applied by a technician. In some aspects, as sloping edge 309 of fastener 140 engages flexible member 412, flexible member 412 deforms to permit fastener 140 to advance in channel 145. As the leading edge 309 moves past flexible member 412, flexible member 412 will snap back toward tapered edge 309 and engage the flat ledge 310 of fastener 140, thereby rigidly holding lid 120 in position against base 110.

In some aspects, to remove lid 120, the user uses a screwdriver or other tool to rotate fastener 140 so that ledge 310 is no longer engaged with flexible member 412. That is, ledge 310 is rotated into a gap in flexible member 412 to permit vertical motion and removal of lid 120.

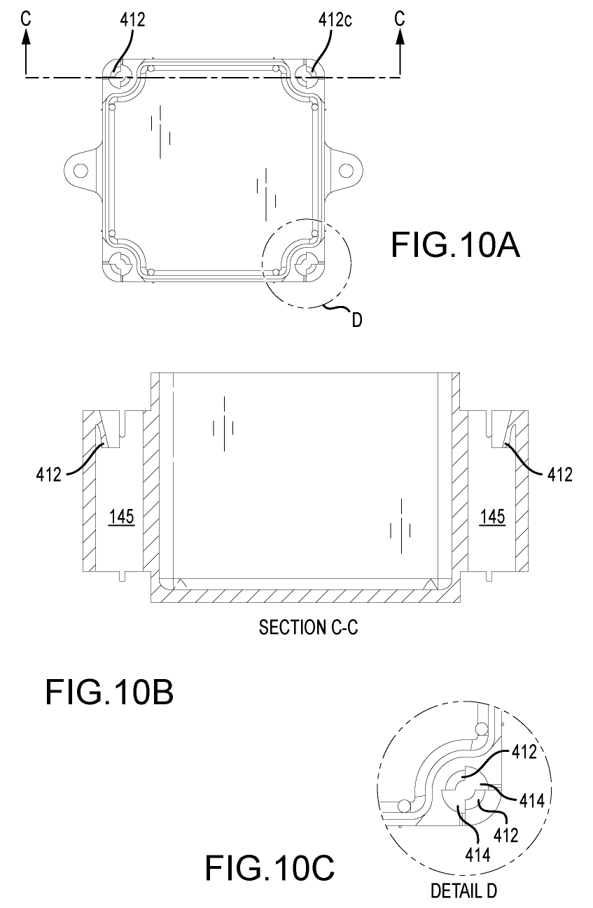

FIG. 10A is a top view of a base 110 showing line C-C and portion D. FIG. 10B is a cross-sectional view of an enclosure along line C-C of FIG. 10A, and FIG. 10C is a detailed view of portion D of FIG. 10A according to some embodiments. In some aspects, FIGS. 10A-C show an example in which each channel 145 is provided with two flexible members 412 each occupying about a quarter of the circumference of channel 145, thereby leaving two gaps 414 occupying the remainder of the circumference. If some aspects, lid protrusions 409 may also occupy about a quarter of the circumference of hole 142, thereby permitting fasteners 140 to be removed from lid 120 by rotating fasteners 140 to fit protrusions 305 and 309 through gaps in lid protrusions 409. In some aspects, lid protrusions 409 could be rotated by 90 degrees (or any other angle) relative to flexible members 412 to require rotation of fastener 140 prior to removal, but this is not required.

In some aspects, if base 110 is formed though injection molding, the flexible members 412 present within channels 145 may be difficult to manufacture. Rather than placing flexible members 412 within channels 145, other embodiments could permit a portion of channel 145 to itself be flexible, thereby permitting advancement and removal of substantially rigid fasteners 140.

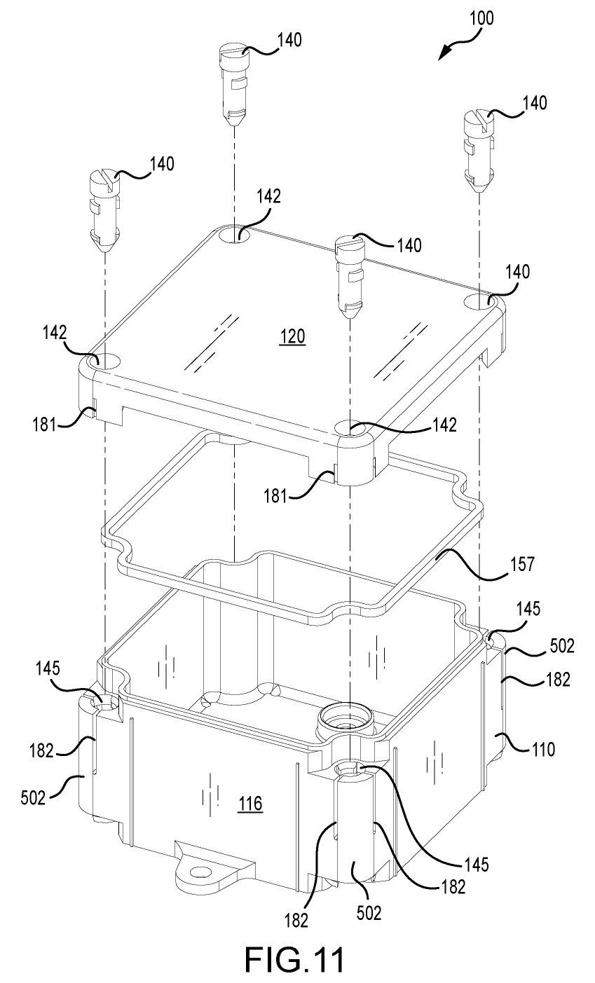

FIGS. 11-13 show slots 182 in base 110 deep enough that a portion 502 of the exterior side wall 116 of base 110 is itself deformable according to some embodiments.

FIG. 11 is an exploded perspective view of an enclosure 100 according to some embodiments. In some aspects, slots 182 are extended to be about halfway (or so) of the length of channel 145 to provide a bit of flexibility in a portion 502 of the exterior wall 116 between slots 182.

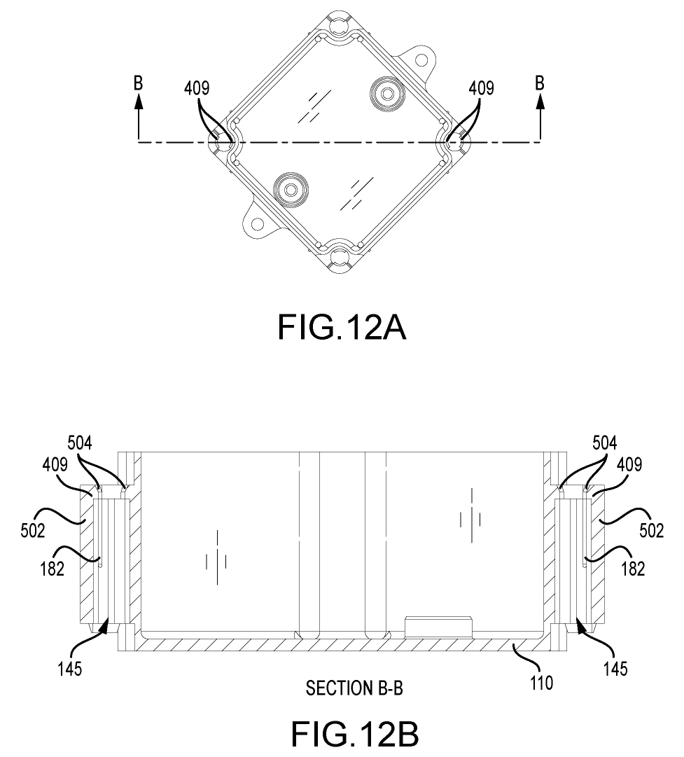

FIGS. 12A-B show an enclosure base 110 with FIG. 12A illustrating a cross-section view along line B-B of FIG. 12B. For example, FIG. 12A shows that the mouth of channel 145 may include beveling 504 to direct fastener 140 into channel 145, and to provide a bit of leverage to encourage outward movement of wall portion 502. Other embodiments may omit the beveling 504, if desired.

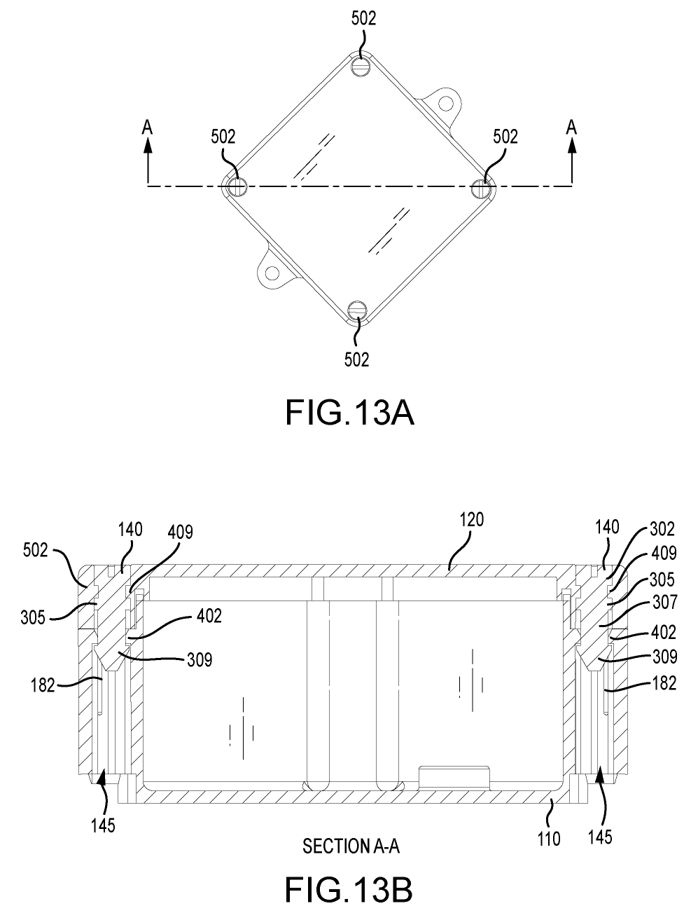

FIGS. 13A-B illustrate an example of a base 110 and lid 120 assembly according to another embodiment. FIG. 13A is a cross-section view along line A-A of FIG. 13B. For example, FIGS. 13A-B illustrates fasteners 140 holding lid 120 against base 110. In some aspects, lid protrusion 409 is present to interface with head 302 of fastener 140, as in the prior embodiments. Similarly, base protrusion 402 is present within channel 145 to snap against ledge 310 of fastener 140. Unlike flexible members 412 described above, however, base protrusion 402 is generally designed to be relatively rigid to encourage flexing of wall portion 502 rather than flexing of protrusion 402. As fastener 140 is advanced within channel 145, then, sloping edge 309 pushes against rigid protrusion 402 to encourage lateral outward movement of protrusion 402 against sloping edge 309 due to flexing of wall portion 502. As sloping edge 309 passes protrusion 402, wall portion 502 suitably snaps the protrusion 402 back toward the center of channel 145, thereby retaining protrusion 402 against flat ledge 310 of fastener 140. Fastener 140 is therefore retained in position until it is rotated (e.g., using a tool applied to slot 303) so that protrusions 409 fit within gaps between protrusion 402, thereby permitting upward movement of lid 120, as in the prior embodiment.

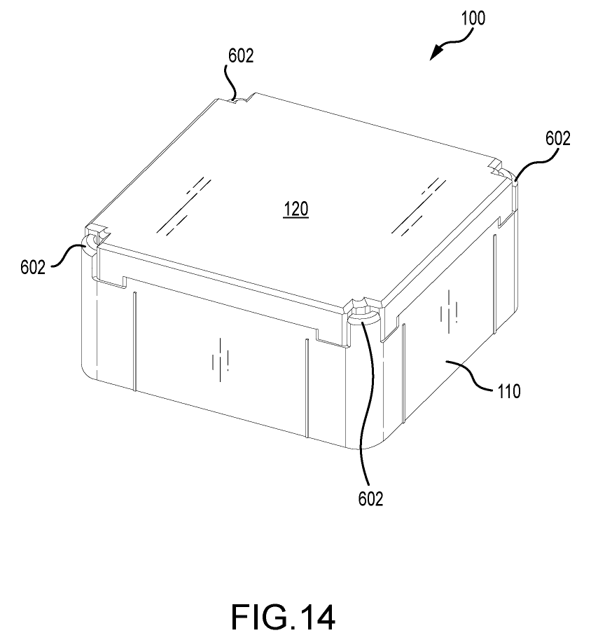

FIG. 14 is a perspective view of an enclosure 100 having a lid 120 according to some embodiments. For example, FIG. 14 shows an alternate embodiment of an enclosure100 in which snap features on lid 120 and/or base 110 are used in place of fasteners 140. In some aspects, snap features 602 are molded or otherwise integrally formed with base 110 to mate with corresponding features of lid 120.

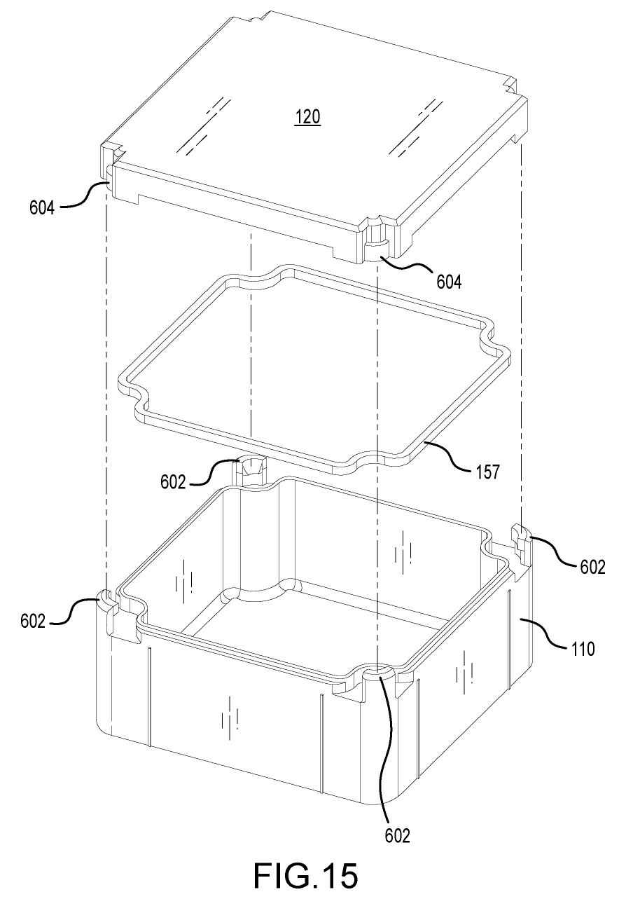

FIG. 15 is an exploded view of an enclosure 100 having a lid 120 according to some embodiments. In some aspects, lid 120 is formed with flat surfaces of lid feature 604 that can be retained beneath snap features 602 of the base for secure attachment. As with prior embodiments, gasket 157 may be provided. Lid features 604 may be shaped in any manner. In one embodiment, surfaces 604 are sloped to apply outward pressure on the base features 602 until the features 602 snap back against a substantially flat surface. Other embodiments may be shaped in any other manner.

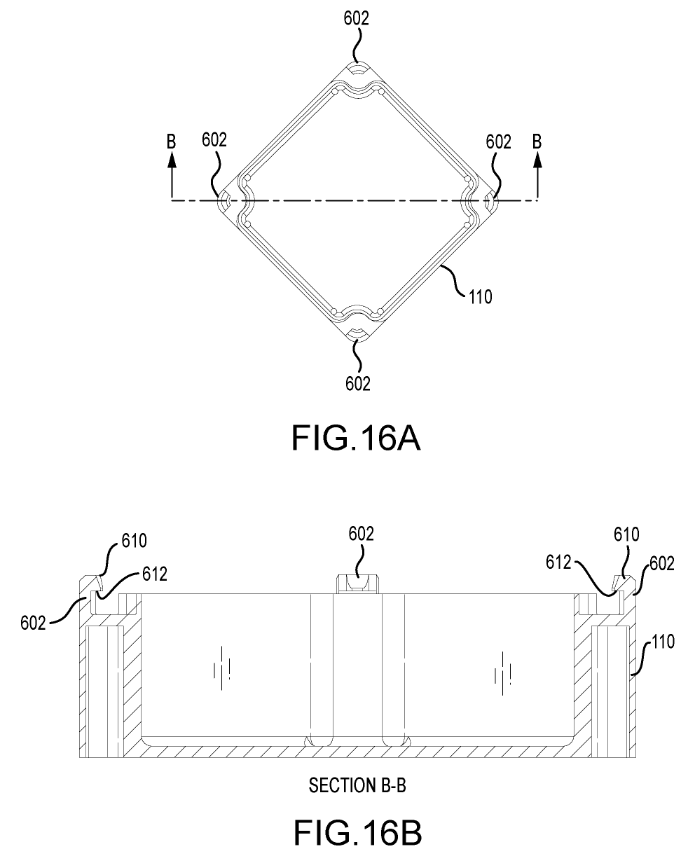

FIGS. 16A-B show additional detail of the snap features 602 that can be molded or otherwise integrally formed with base 110. FIG. 16B is a cross-section view along line B-B of FIG. 16A, which illustrates a base 110 according to some embodiments. In some aspects, snap features 602 include a hook-type structure 610 that is flexible enough to deform when lid 120 is pressed against the top of base 110, but that snap back into position after the corresponding features 604 of lid 120 have passed. A flat surface 612 remains in position against the top of lid features 604 so that lid 120 is held against base 110, as appropriate. Removal of lid 120 will generally require the use of a screwdriver or other pry tool to move hook structures 610, thereby permitting lid features 604 to be moved.

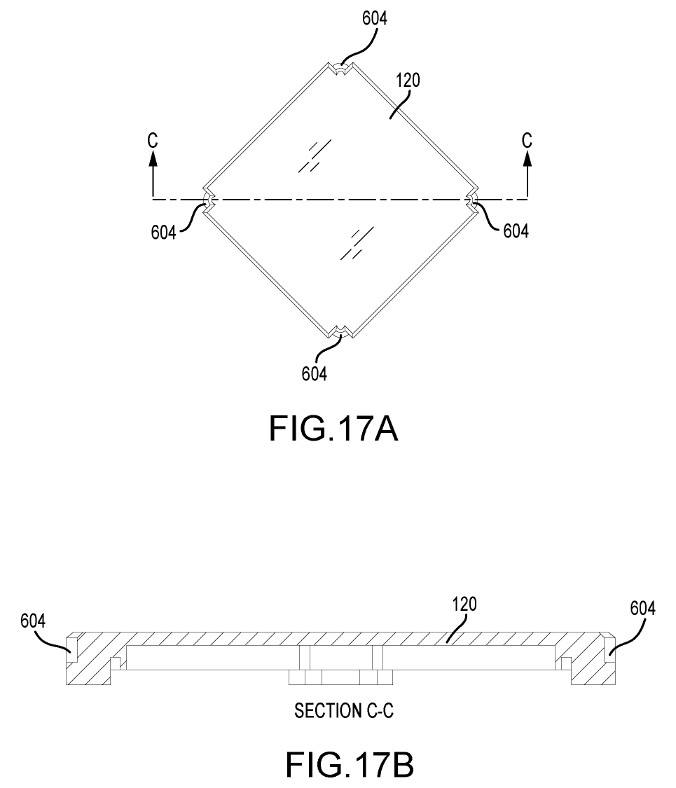

FIGS. 17A-B illustrate a lid 120 according to some embodiments. FIG. 17B is a cross-section view along line C-C of FIG. 17A. For example, FIG. 17 shows additional detail of lid 120 that mates with base 110 as illustrated in FIG. 16. In some aspects, three to four points of contact can be used to secure lid 120 to base 110. Different embodiments may include any combination of structures to achieve such contact, such as fasteners 140, tab/loop structures, hinges and/or the like.

It is to be appreciated that although many of the various embodiments described herein generally show four fasteners or snap points for attaching the lid to the base, equivalent embodiments could use one or two fasteners and/or snap points in conjunction with hinges and/or other pivot points, and/or other retention structures as desired.

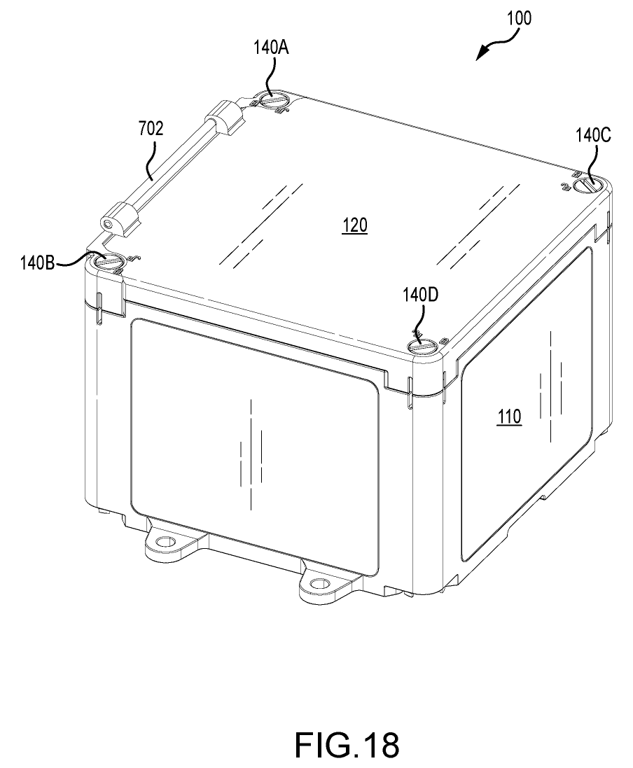

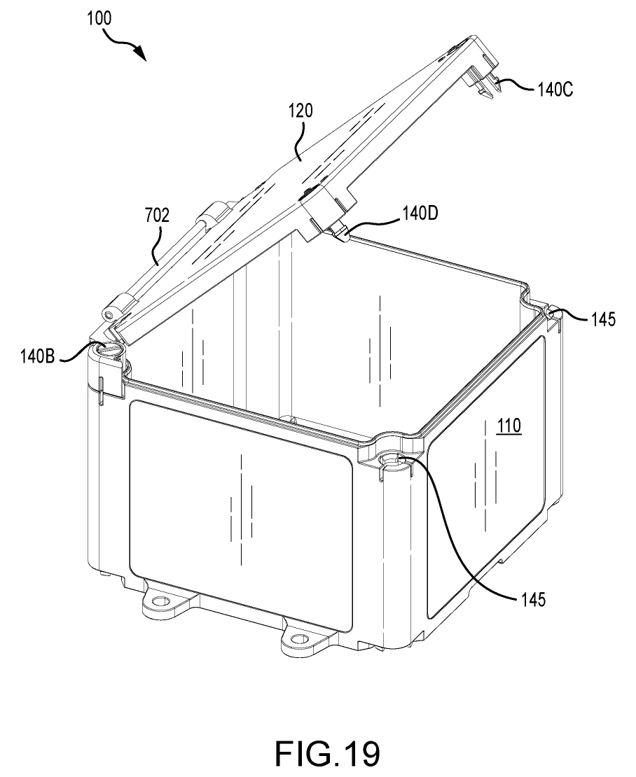

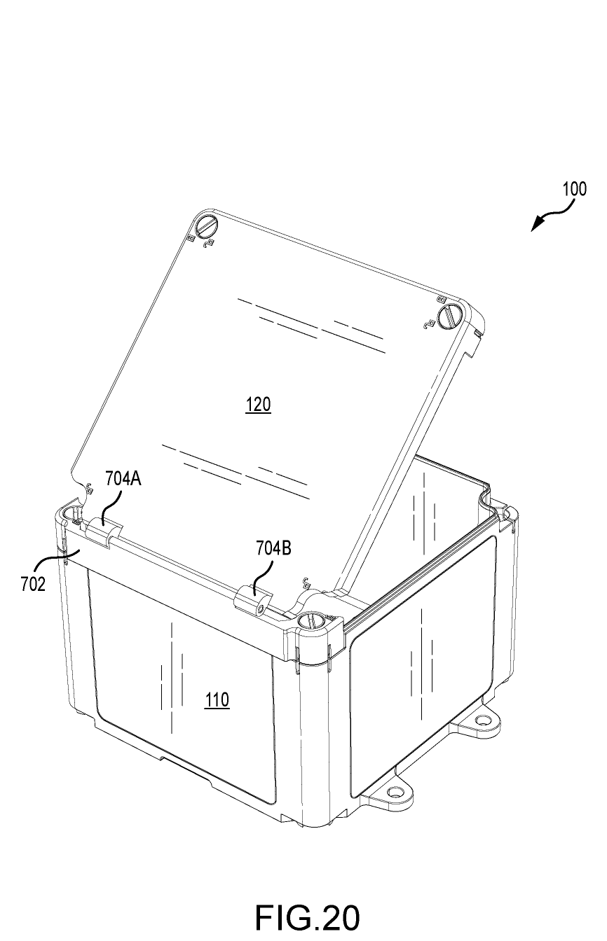

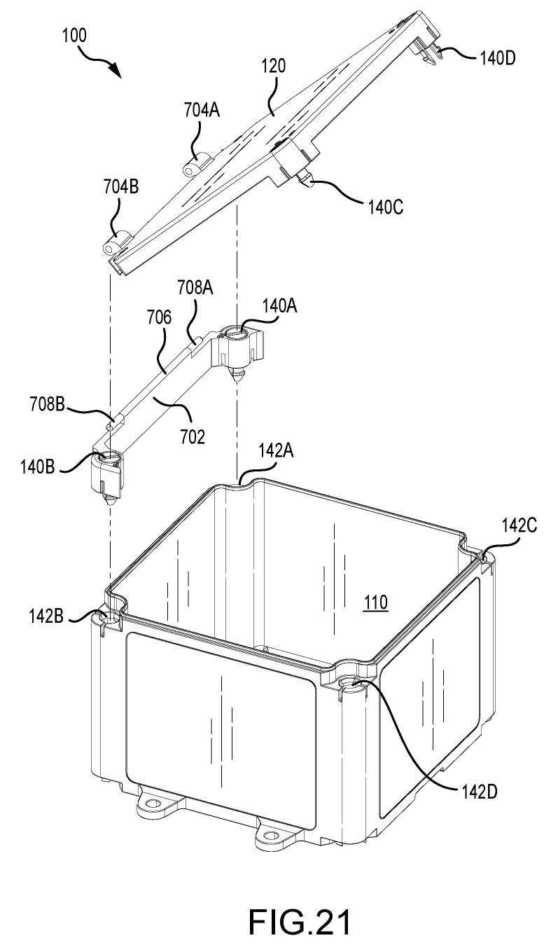

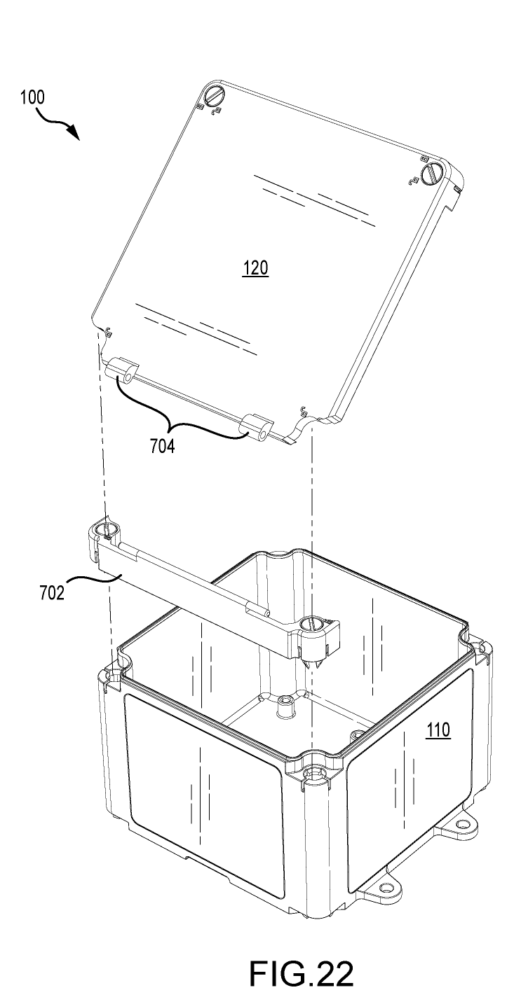

FIG. 18 is a perspective view of an enclosure having a closed, hinged lid 120 according to some embodiments. FIGS. 19-20 are perspective views of an enclosure 100 having an open, hinged lid 120 according to some embodiments. FIGS. 21-22 are exploded views of an enclosure 100 according to some embodiments. In some aspects, FIGS. 18-22 illustrate an enclosure 100 that includes a hinge adapter 702 that affixes to lid 120 to provide a hinged opening mechanism for accessing the interior of base 110.

Turning to FIG. 20, hinge adapter 702 includes a hinge mechanism 706 that mates with one or more hinge receptacles 704 that are attached to or formed as part of lid 120. In this example, hinge adapter 702 accepts one or more snap fasteners 140A-140B that pass through holes 142A-142B in adapter 702 and are held fast within holes 145A-145B of base 110, respectively. In this example, base 110 is fashioned as described above, and lid 120 is modified to include the hinge receptacles 704 to provide the hinged opening (compare FIG. 18 to FIG. 19). FIGS. 21 and 22 provide front and rear exploded views, respectively, of example enclosures 100 having a hinge adapter 702 that couples lid 120 to base 110.

Although FIGS. 17-22 illustrate an embodiment wherein the base 110 has a single hinge adapter 702, equivalent embodiments could use two or more adapters 702. In that case, each adapter 702 could receive a single snap fastener 140 while providing one end of the hinge mechanism 706 that mates with hinge receptacle 704 on lid 120. Other embodiments could be fashioned wherein the hinge is implemented in any other manner using one or more adapters 702 having any orientation and design.

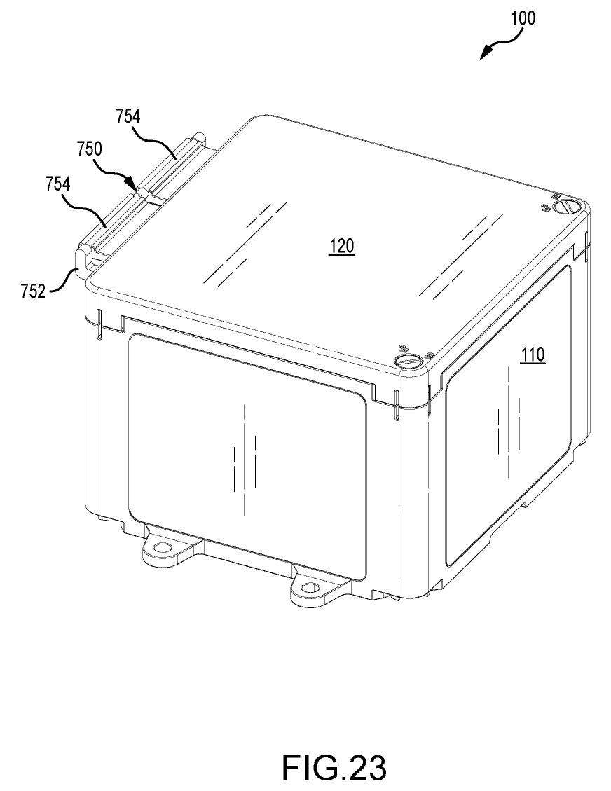

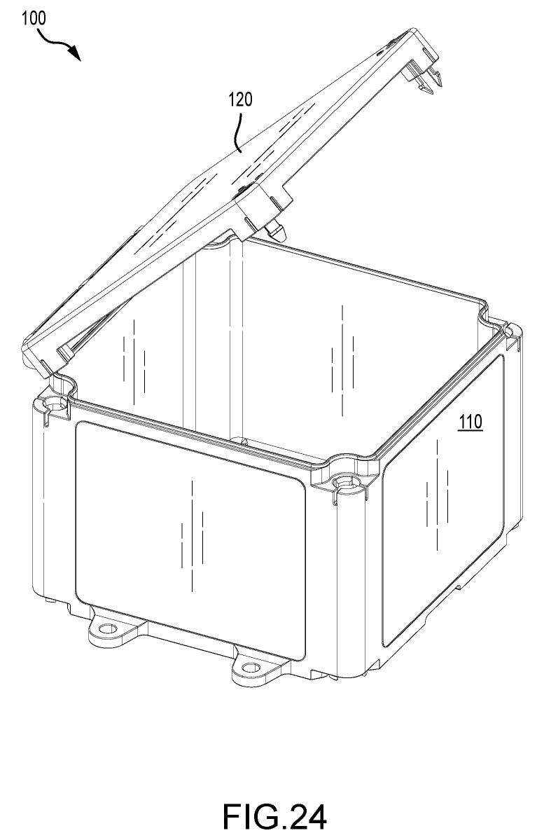

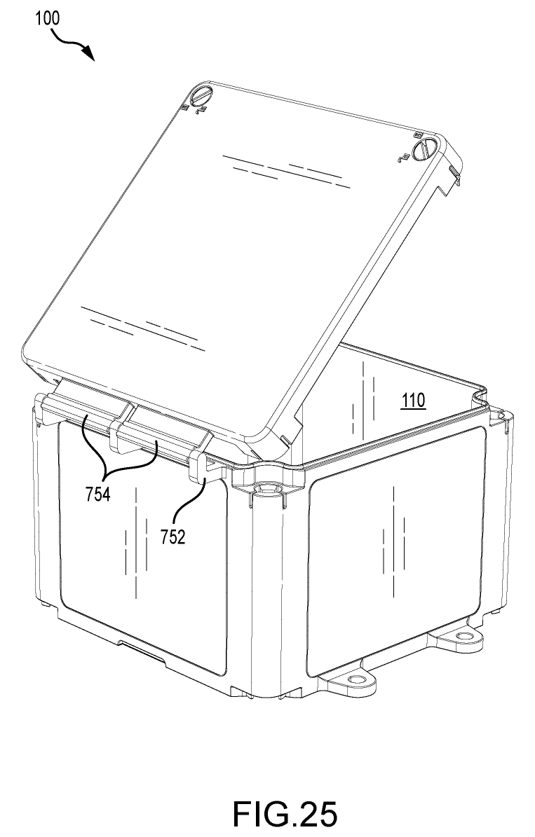

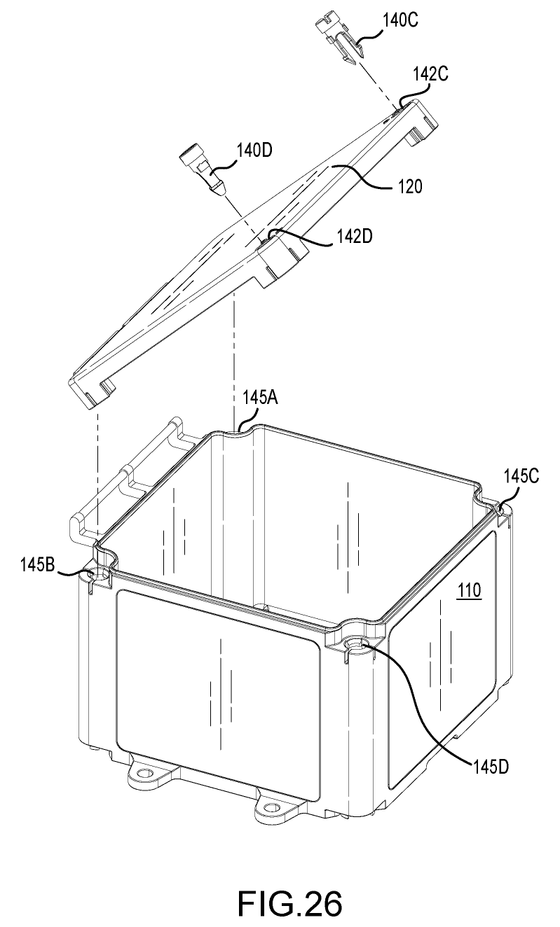

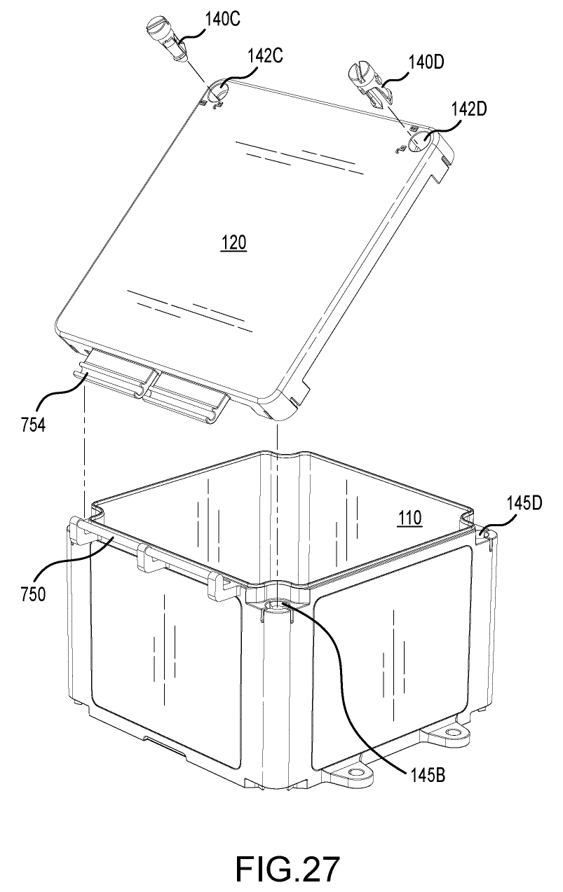

FIG. 23 is a perspective view of an enclosure 100 and lid 120 according to some embodiments. FIGS. 24-25 are perspective views of an enclosure 100 and lid 120 in an open position according to some embodiments. FIGS. 26-27 are exploded views of an enclosure 100 according to some embodiments. For example, FIGS. 23-27 show an embodiment that may eliminate adapter 702 and instead form hinge components as attachments or integral parts of base 110 and/or lid 120. In some aspects, these figures illustrate an embodiment in which a hinge 750 is formed by one or more base portions 752 that cooperate with one or more lid portions 754. In this example, the base portion 752 is molded or otherwise formed with base 110 to include a horizontal member that is received within slots of lid portion(s) 754. Lid portions 754 may be similarly molded or otherwise integrally formed with lid 120. Equivalently, base portion 752 and/or lid portions 754 may be formed as separate members that are plastic welded or otherwise attached to base 110 and lid 120, respectively.

In the example of FIG. 27, various embodiments include slots formed in lid portions 754 that accept the horizontal member of base portion 752 to support rotational movement about hinge 750. Hinges of any other sort could be equivalently used. In this example, holes 145A and 145B of base 110 are not used, but holes 145C and 145D accept snap-type fasteners 140C and 140D, respectively, as in the embodiments above. Retaining holes 145A, 145B while providing a base portion 752 allows base 110 to be used with different types of lids 120. If a four-snap lid 120 were to be used in place of the hinged lid 120, for example, the hinge members 752, 754 could be snapped or clipped away.

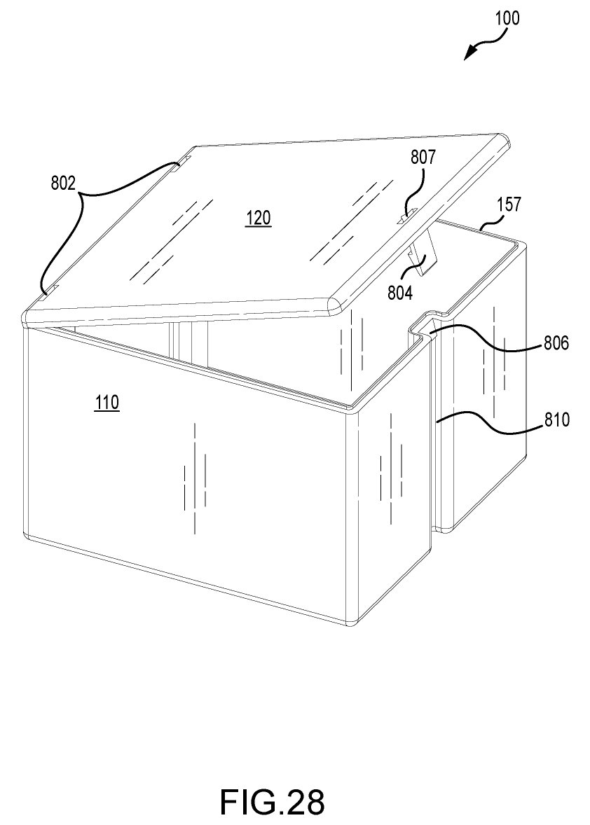

FIGS. 28-38 illustrate another enclosure 100 in which one side of lid 120 is retained by hooks 802 and/or a hinge 750 while the opposite side is retained in place by one or more built-in snaps 804. Snap 804 is biased toward a slot 807 in lid 120 so that snap 804 latches and is held in place by a ledge 806. To open the box, a technician inserts a screwdriver, knife or similar tool into slot 807 to ease the snap 804 away from ledge 806, thereby permitting lid 120 to open away from base 110. Ledge 806 may be formed within a slot or other recess 810 of base 110, if desired, to permit more compact geometry and a smooth front wall face, as appropriate.

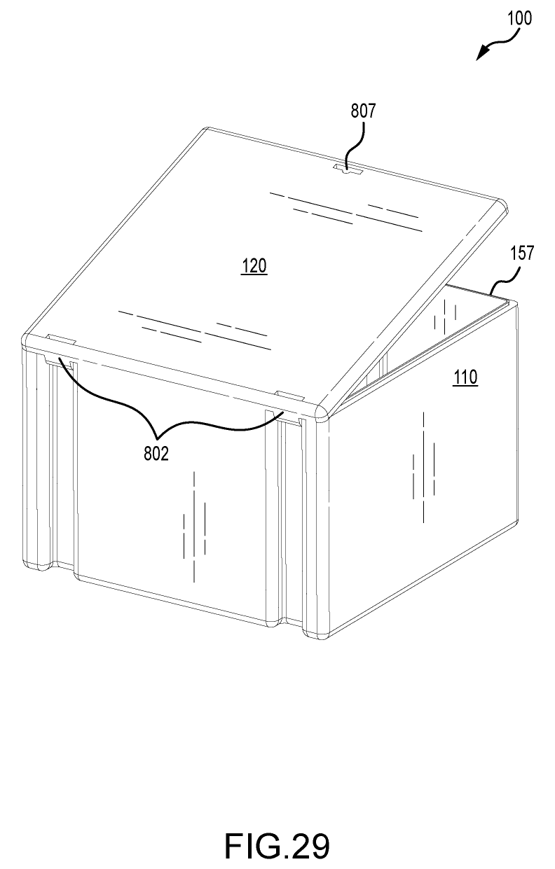

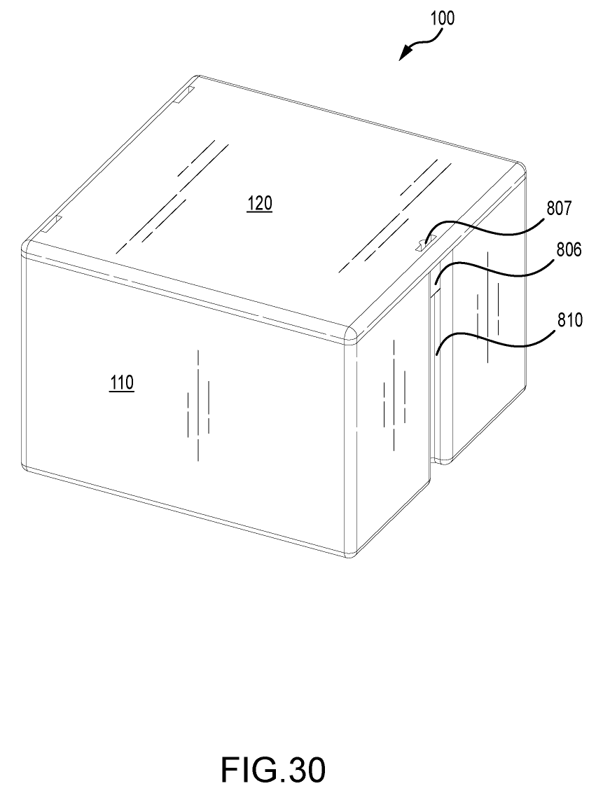

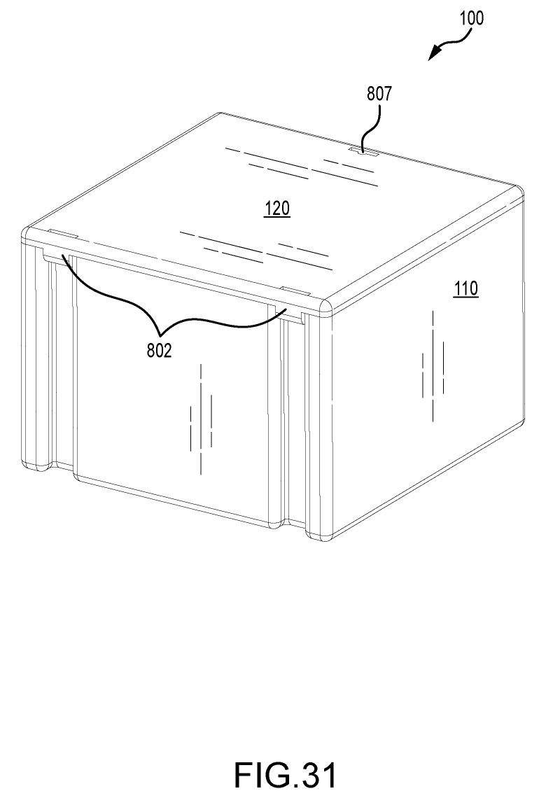

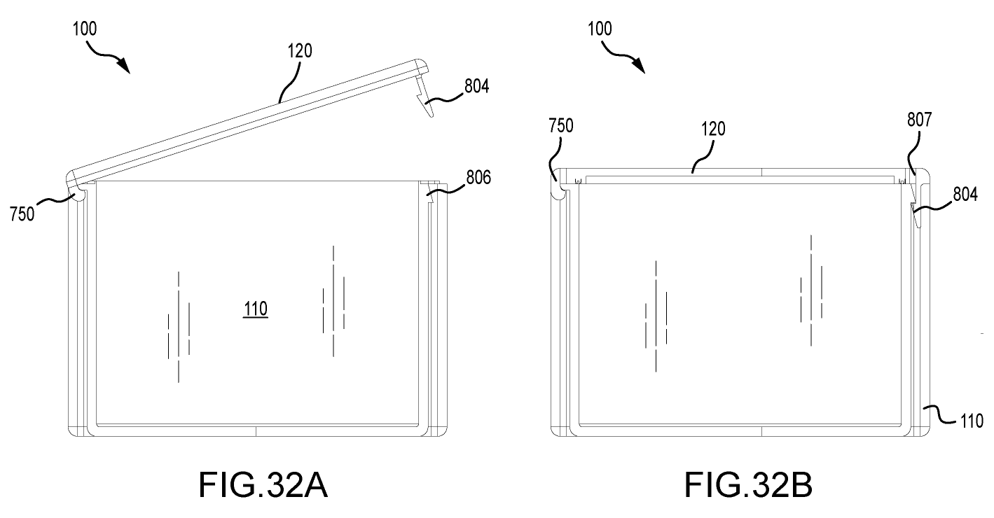

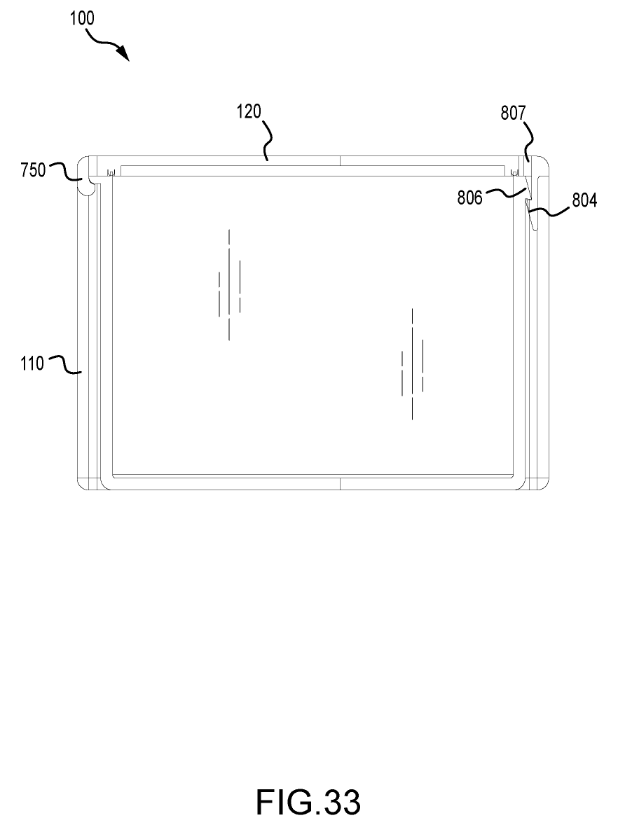

FIGS. 28-29 are perspective views of an enclosure 100 and lid 120 in an open position according to some embodiments. FIGS. 30-31 are perspective views of an enclosure 100 and lid 120 according to some embodiments. FIGS. 32A and 32B show open and closed views, respectively, of a hinged enclosure 100 and lid 120 according to some embodiments. FIG. 33 is a side view of an enclosure 100 and hinged lid 120 according to some embodiments. For example, FIGS. 28-33 show the side of lid 120 opposite snap 804 retained in place using hooks 802 that mate with slots formed in base 110.

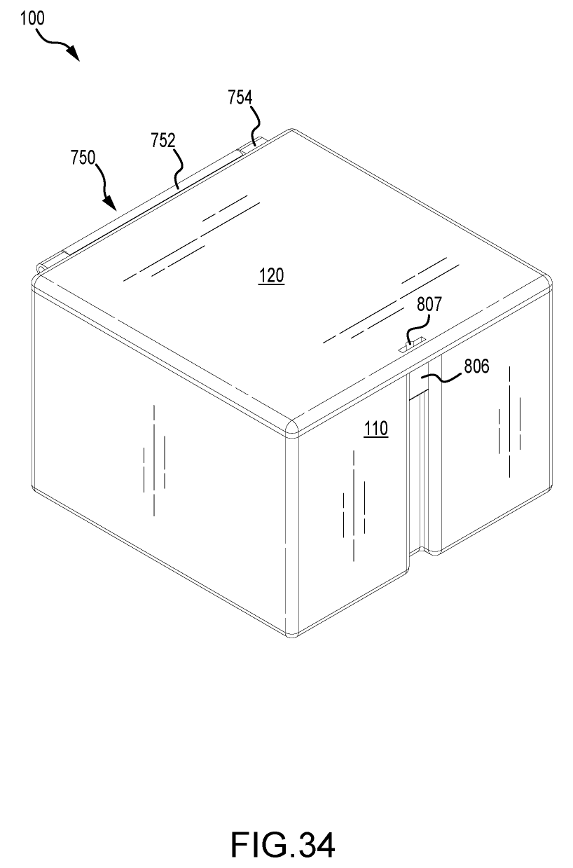

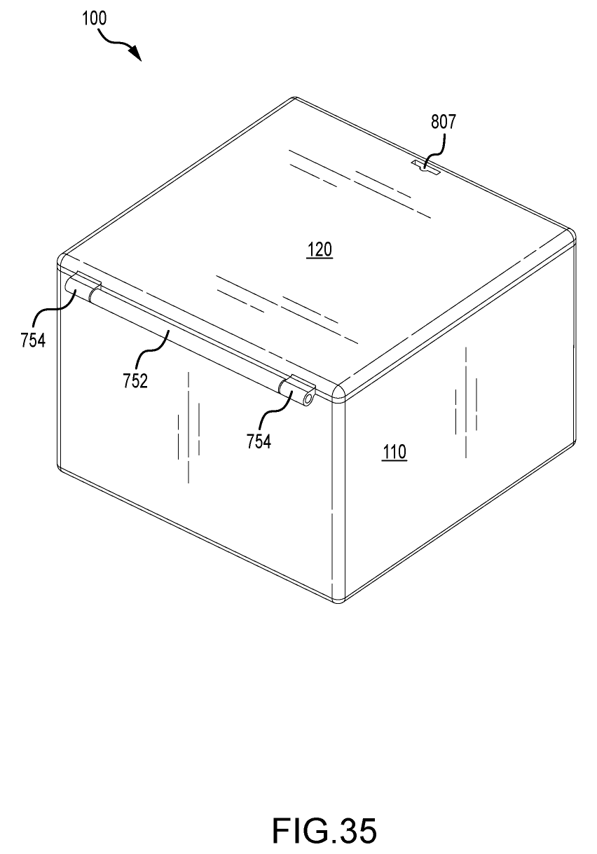

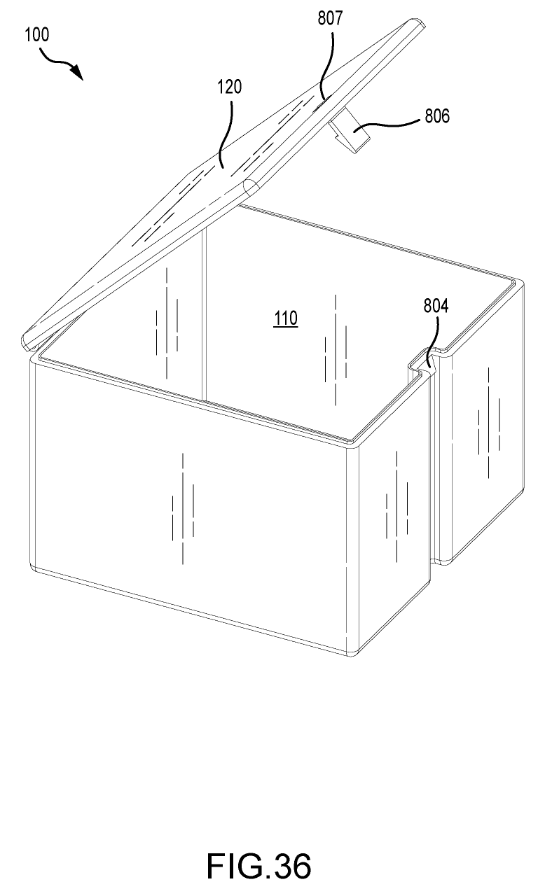

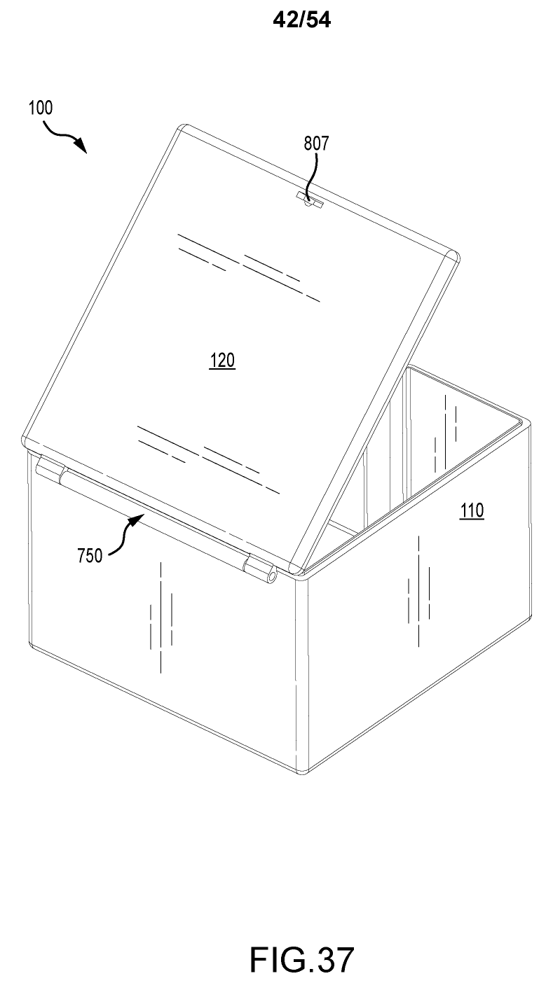

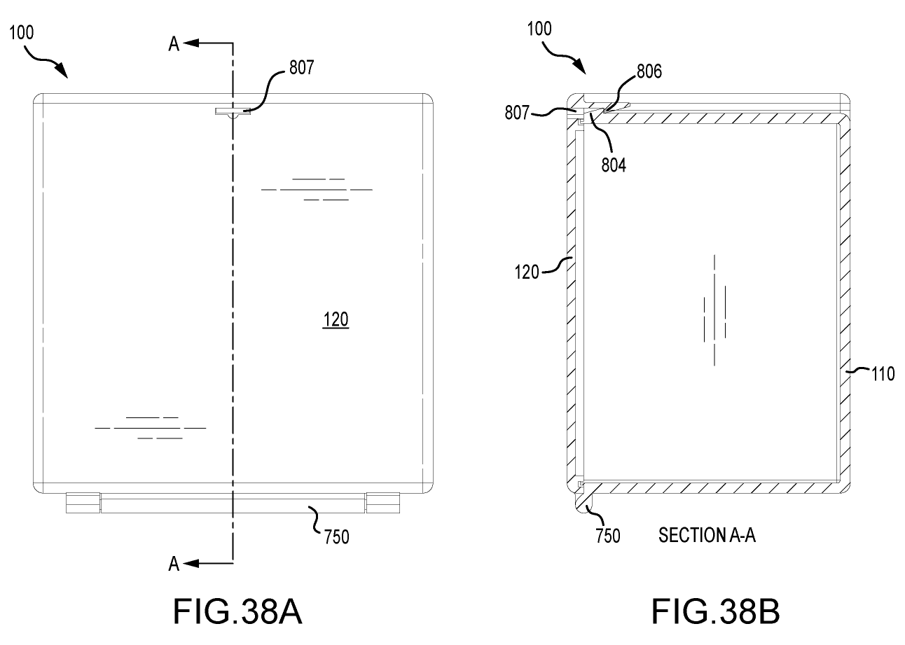

FIGS. 34 and 35 are perspective views of an enclosure 100 and hinged lid 120 in closed positions according to some embodiments. FIGS. 36 and 37 are perspective views of an enclosure 100 and hinged lid 120 in open positions according to some embodiments. FIG. 38A and 38B are top views of an example enclosure 100, with FIG. 38B showing a cross-section view along line A-A of FIG. 38A. For example, FIGS. 34-38 show that any sort of hinge could be provided.

In any of the various embodiments, gasket 157 may be provided to form a tighter seal between base 110 and lid 120. As noted above, gasket 157 may be formed in place on either lid 120 and/or base 110 using composite deposition techniques. In some aspects, a separate gasket 157 formed of rubber, soft plastic and/or any other material could be provided that is glued or otherwise attached to base 110 or lid 120. In some aspects, a gasket 157 may not be needed if the fit between base 110 and lid 120 is sufficiently tight for the particular purpose of that enclosure 100. In some aspects, additional tightness may be created by adjusting the tension of springs or hinges, and/or adjusting the tension of fasteners 140, as appropriate. In some aspects, slots or ridges could also be formed in the surfaces of base 110 and/or lid 120 that mate with each other, thereby creating greater interface surfaces for tighter fit and better water and dust resistance.

In some aspects, another way to increase tension between base 110 and lid 120 could involve designing fasteners 140 to apply additional tension.

FIGS. 39A and 39B are side and perspective views of fasteners 140 according to some embodiments. For example, these figures show a snap-type fastener 140 that is similar to that shown in FIG. 3 above, but with the addition of a ramp portion 325 and/or additional interference feature(s) or structure 323. In some aspects, fasteners 140 could be manually inserted using simple physical pressure, as described above. In some aspects, after lid 120 with fasteners 140 is pressed into place, fasteners 140 may then be turned (e.g., using a knife, screwdriver or similar tool) so that the ramp portion 325 and interference structure 323 of protrusion 305 applies additional upward pressure against protrusions 402 or other features of lid 120, thereby acting as a wedge that applies an additional sealing force. In some aspects, one or more wedge structures 323 on the ledges 310 of legs 307 that would apply upward pressure against the underside of protrusions 402 in holes 155 in base 110. In some aspects, enclosure 100 closes and retains lid 120 with mere application of physical pressure by a technician, but additional manipulation of fastener 140 (e.g., by turning the fastener 140 with a tool) advances the rotation against wedge structure(s) 323, thereby providing a tighter seal between lid 120 and base 110. Although the example described herein uses quarter turns to seal, unseal and open enclosure 100, other embodiments could be fashioned so that larger or smaller turns produce similar results.

In still other embodiments, wedge structures could be added to protrusions 402 and/or 409 within holes 142 in lid 120 and/or channels 145 in base 110. Wedge structures 872 are suitably positioned to apply additional pressure against fasteners 140, thereby increasing the compression between lid 120 and base 110 when the fasteners 140 are appropriately tightened within holes 145.

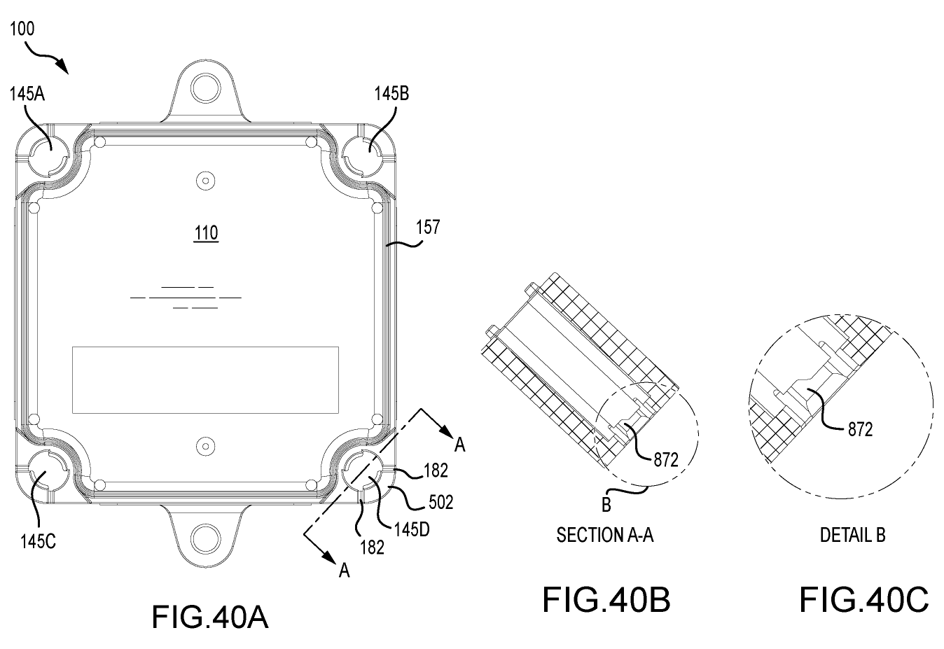

FIGS. 40A-C are top views of an enclosure 100 according to an example embodiment. FIG. 40B is a cross-section view of a portion of enclosure 100 along line A-A of FIG. 40A according to some embodiments, and FIG. 40C is a detailed view of area B in FIG. 4B according to some embodiments. In some aspects, a wedge structure 872 is located in the bottom of channel 145 so that a fastener 140 abutting the bottom of the channel 145 can be tightened against the wedge structure 872, which applies pressure against fastener 140 that is delivered to optional gasket 157, or that otherwise holds lid 120 more tightly against base 110.

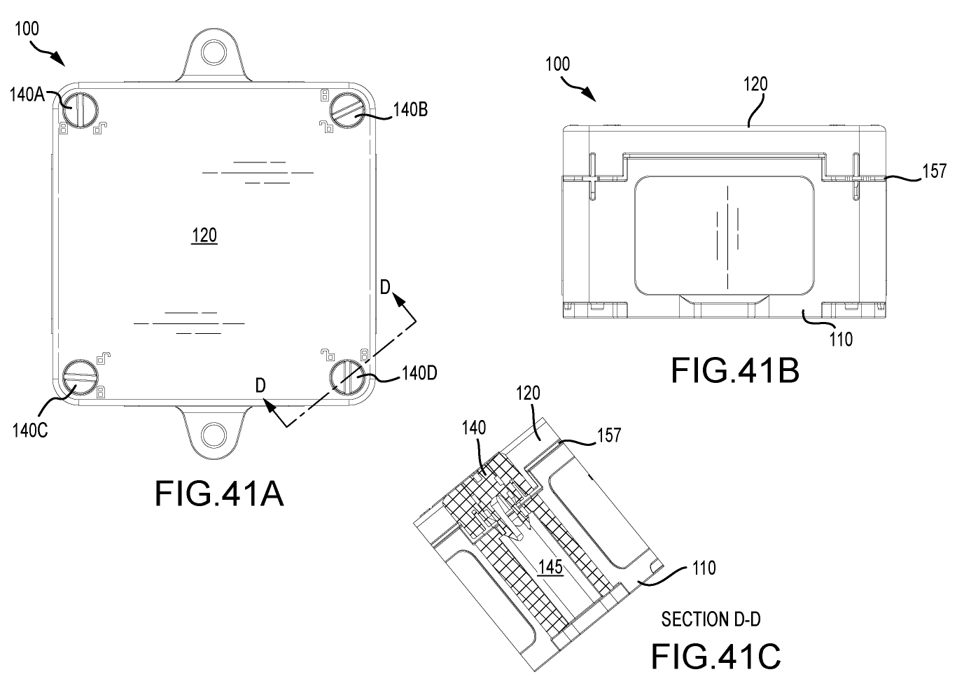

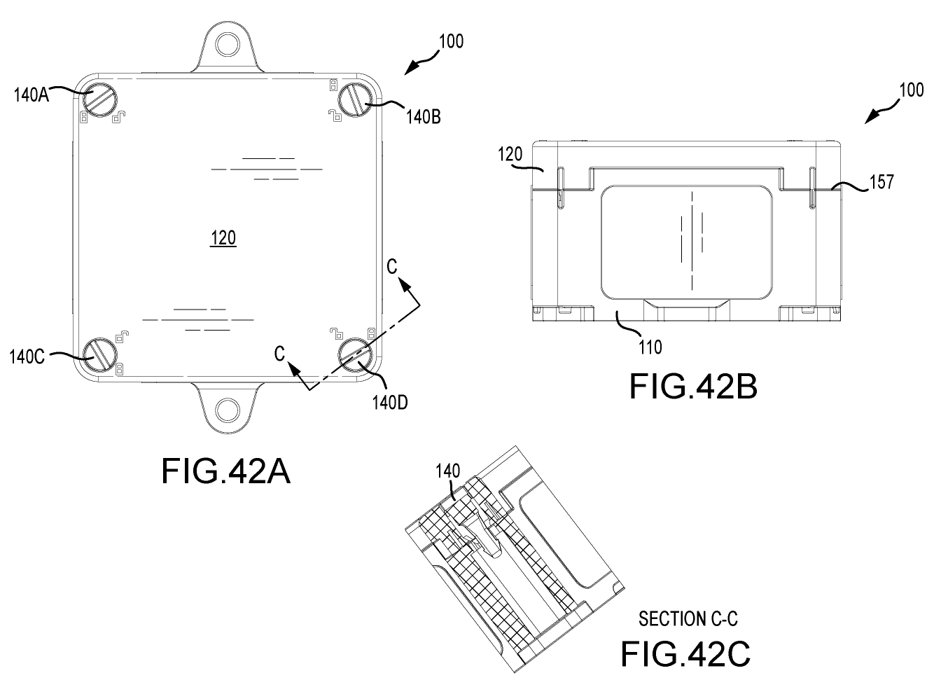

FIGS. 41A and 41B are top and front views, respectively, of an enclosure 100 and lid 120 according to some embodiments. FIG. 41C is a cross-section view along line D-D of FIG. 41A according to some embodiments. FIGS. 42A and 42B are top and side views, respectively, of an enclosure 100 and lid 120 according to some embodiments. FIG. 42C is a detailed view along line D-D of FIG. 42A according to some embodiments. For example, FIGS. 41-42 illustrate another embodiment of enclosure 100 in which one or more base protrusions 402 (see FIG. 4 above) include wedge structures 872 to increase pressure between lid 120 and base 110.

With respect to FIGS. 41A-C, lid 120 is pushed or otherwise manually positioned so that fasteners 140A-140D passing through lid 120 are inserted into base holes 145. Wedge structures 872 on the bottom of protrusions 402 in base 110 apply additional compressive force when fastener 140 is advanced against wedge structure 872. Compressive force in this example would be a downward force if wedge structure 872 were formed on the underside of base protrusions 402.

In another embodiment, one or more wedges 872 could be applied to a top surface of lid protrusion 409, if desired, to provide upward force that would be translated from ledge 310 of fasteners 140 against base protrusions 402. In some aspects, wedge structures 872 are located in other positions within lid 120, base 110 and/or on fasteners 140 to increase the compressive force applied between lid 120 and base 110 through further rotation, as appropriate.

In the example of FIGS. 41A-C, lid 120 has been manually pressed against base 110 so that fasteners 140A-140D have been inserted into channels 145, as discussed above. This manual force may be sufficient to maintain lid 120 in the closed position due to the interaction of legs 307 and protrusions 402, as described above.

In this example, further rotation of one or more fasteners 140 provides the additional compressive force though the interaction of fasteners 140 with wedge structures 872. In other embodiment, further rotation provides additional compressive force between interference structures 343 on fasteners 140 and protrusions in channels 145, as described above.

Comparing FIGS. 41A-C to FIGS. 42A-C, additional rotational force applied to fasteners 140 (see, e.g., fastener 140D in FIG. 42) has been applied, resulting in additional compression. This can lead to better compression on a gasket 157, if present, and in any event may lead to better resistance to moisture, dust or other contaminants. This improved seal could result in a better rating through the National Electrical Manufacturers Association (NEMA) or a similar entity.

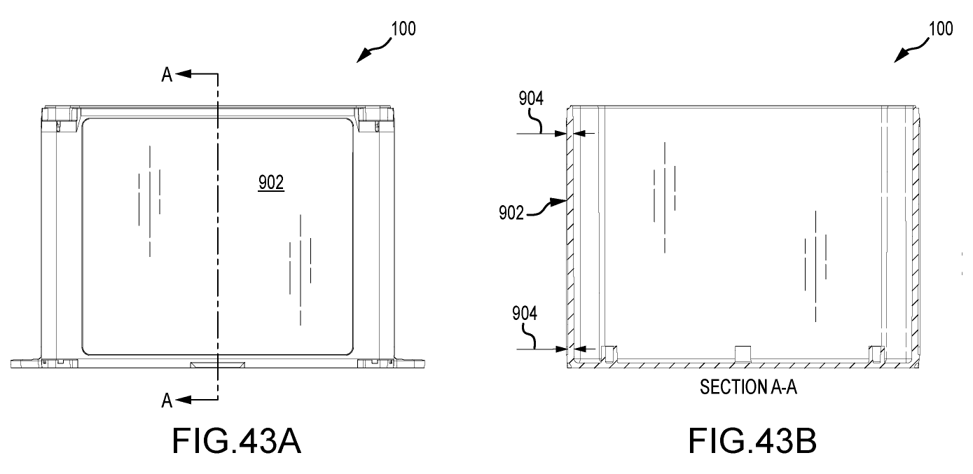

FIG. 43A is a side view of an enclosure 100 according to some embodiments, and FIG. 43B is a cross-section view along line A-A of FIG. 43A. In various embodiments, one or more sidewalls of base 110 can be molded or otherwise formed with a drill zone 902 that is thinner than the surrounding structures of base 110. Drill zones 902 may permit the installer to create holes at any location within the zone to accommodate conduit, wires or other components needing access to the interior of enclosure 100. In contrast to a knockout or other pre-defined hole, drill zone 902 may provide increased flexibility because user-drilled holes can be made in any convenient location within the zone, allowing the user to avoid inconvenient locations near other components, in tight spaces, or the like. Moreover, the thickness 904 of drill zone 902 can be designed to be uniform across the entire area of drill zone 902. In some example embodiments, drill zone 902 can be designed with a uniform wall thickness 904 of between about 0.1 inches and 0.2 inches, such as about 0.15 inches, or about 0.145 inches. Although other embodiments could have other dimensions suitable for the particular application and setting, using a wall thickness 904 within this general range provides compatibility with readily available metal fittings that were designed for use with thinner metal enclosures. Such fittings may not be compatible with thicker walls or non-parallel walls that may be found in prior art enclosures, which typically exhibit thicknesses of 0.25 inches or more, and which often have wall thicknesses that vary across the span of the wall making drilling difficult and potentially limiting the locations where certain fittings could be used.

In some embodiments, the relatively low wall thickness 904 results from the use of polycarbonate material, which has a greater strength than other polymers. Uniform thickness 904 across drill zone 902 can be accomplished in some embodiments by providing one or more slides into the mold prior to injection molding, thereby permitting parallel walls between the face of drill zone face 902 and the inside walls of base 110. If a drill zone 902 is desired in each of the four walls in a quadrilateral-shaped enclosure 100, for example, four slides would be placed into the mold before the enclosure 100 was formed, one for each zone 902. Different embodiments could therefore be formulated having any number of drill zones 902 located on some or all of the walls of enclosure 100, as desired.

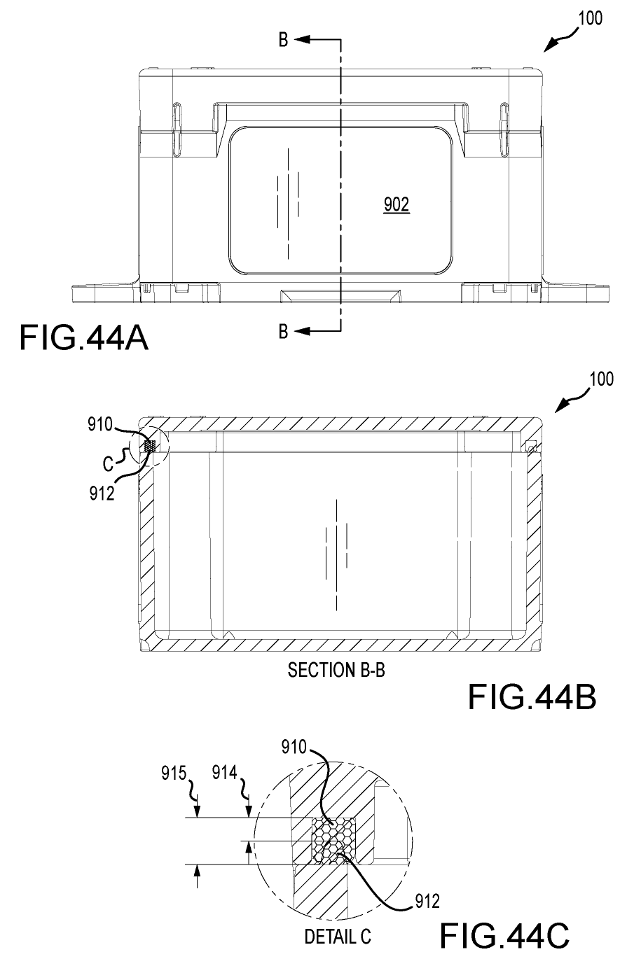

FIG. 44A is a front view of an enclosure 100 according to some embodiments. FIG. 44B is a cross-section view of line B-B in FIG. 44A, and FIG. 44C is a detailed view of region C in FIG. 44B according to some embodiments. In some aspects, using snap-type configuration for fastener(s) 140 can allow for maintaining a reliably constant position of lid 120 relative to base 110 based upon a length of the fasteners 140. For example, enclosures that rely upon tightening of screws may not exhibit this consistency due to variations in how tightly the installer has secured the screws, because screws can be over-tightened thereby resulting in damage to the seal. The consistency provided by snap-type configuration of fasteners 140 can, in some embodiments, reliably ensure that the gasket or other seal between lid 120 and base 110 is properly compressed, thereby achieving desired water protection ratings and performance. In this regard, fasteners 140 may uniformly load the gasket or seal between lid 120 and base 110.

In some embodiments, the seal between lid 120 and base 110 can be improved by adding mechanical structures to lid 120 and/or base 110. FIGS. 44A-44C, for example, show an embodiment wherein lid 120 has a circumferential groove 910 that can be filled with a compressible material (e.g., similar to gasket 157 described above) and base 110 has a circumferential ridge 912 along an upper edge that mates with groove 910 and provides additional compression of the material in groove 910. In the example of FIG. 44C, groove 910 has a depth 915 that is greater than the height 914 of ridge 912; the relative dimensions of groove 910 and ridge 912 could be configured to apply any desired amount of compressive force in other embodiments. Additionally or alternatively, the relative positions of groove 910 and ridge 912 could be equivalently swapped such that groove 910 is present in base 110 and ridge 912 is formed on lid 120, as desired.

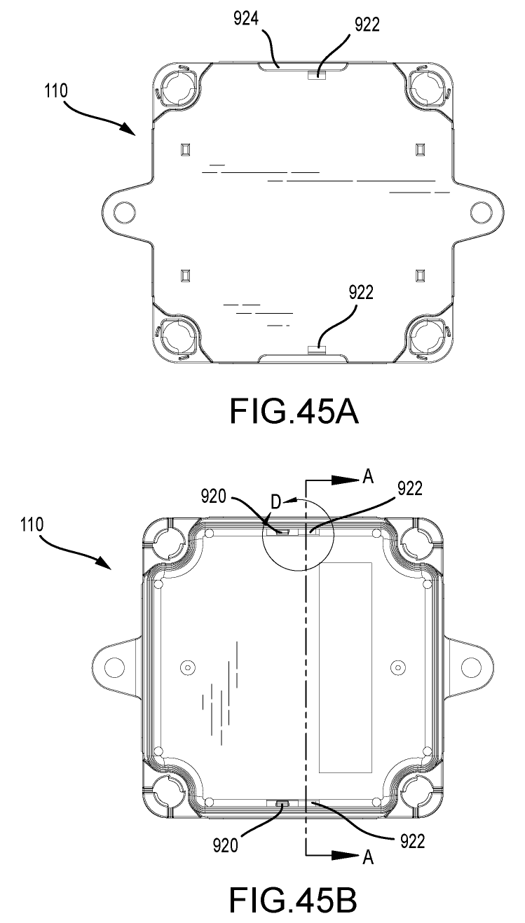

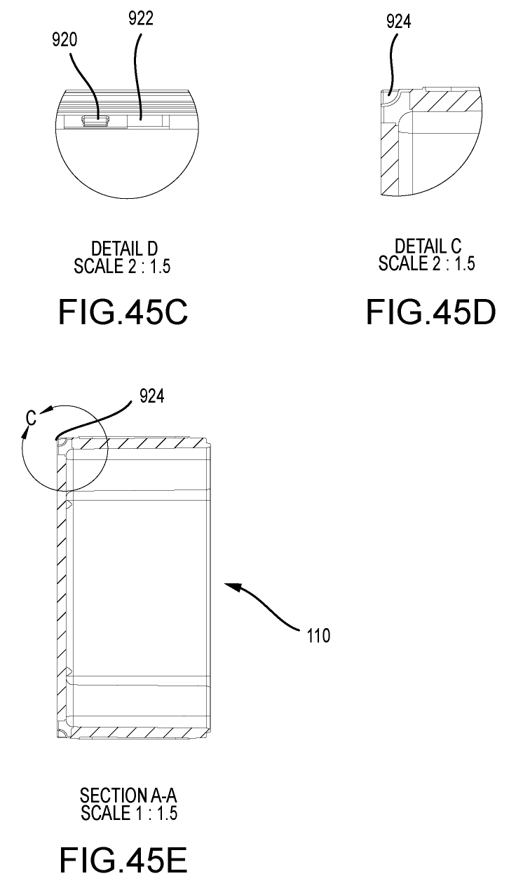

FIGS. 45A and 45B are bottom and top views, respectively, of enclosures according to some embodiments. FIG. 45C is a detailed view of area D of FIG. 4B. FIG. 45D is a detailed view of area C in FIG. 45E, and FIG. 45E is a cross-section view along line A-A of FIG. 4B.

In some embodiments, a slide 920 can be provided to move within a channel 924 to cover or expose a weep hole 922 in base 110. In some aspects, slide 920 provides convenient configurability for different uses, e.g., in settings where condensation or other moisture is likely to form inside enclosure 100, the installer may wish to open weep hole 922 to let the moisture drain away. This drainage can be particularly beneficial in outdoor settings, especially in cold weather, where moisture could otherwise accumulate and/or freeze, potentially shorting or damaging electrical components or connections in the interior of enclosure 100. On the other hand, in some settings dust or other contaminants may be a greater concern. In such cases, the installer may desire to move the slide 920 so that hole 922 is covered, thereby providing better resistance to dust or the like. FIGS. 45A-45E illustrate an example embodiment wherein the weep hole 922 is open to permit moisture to drain away from the interior of enclosure 100.

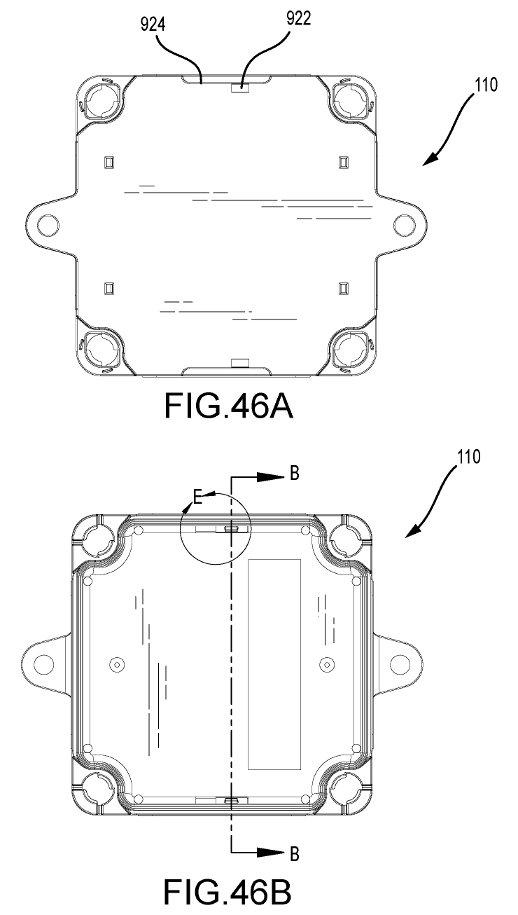

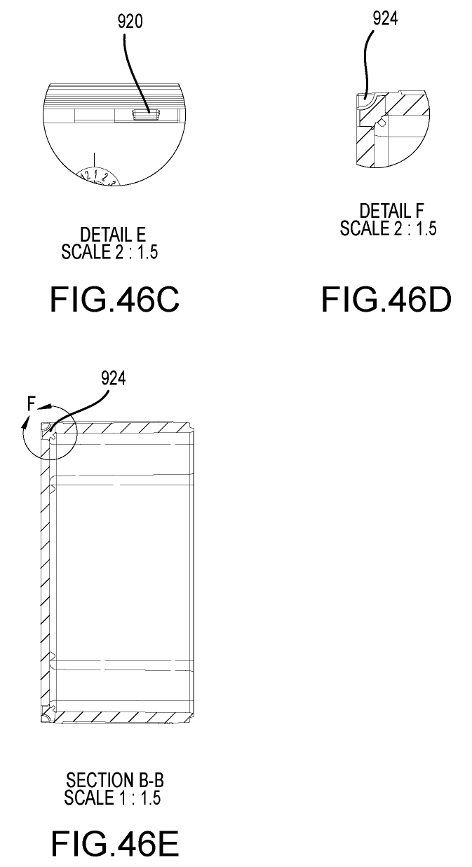

FIGS. 46A and 46B are bottom and top views, respectively, of enclosure 100 according to some embodiments. For example, these figures may show slide 920 has been moved within channel 924 so that weep hole 922 is closed.

FIG. 46C is a detailed view of area E of FIG. 45B, FIG. 45D is a detailed view of area F in FIG. 46B, and FIG. 46E is a cross-section view along line B-B of FIG. 46B according to some embodiments.

In some aspects, by moving the slide 920 within channel 924, the installer or user can configure enclosure 100 for drainage (FIGS. 45A-45E) or contaminant resistance (FIGS. 46A-46E) as desired. This configurability is an optional feature that may not be found in other embodiments; still other embodiments could implement hole coverings in any other manner using any other structures.

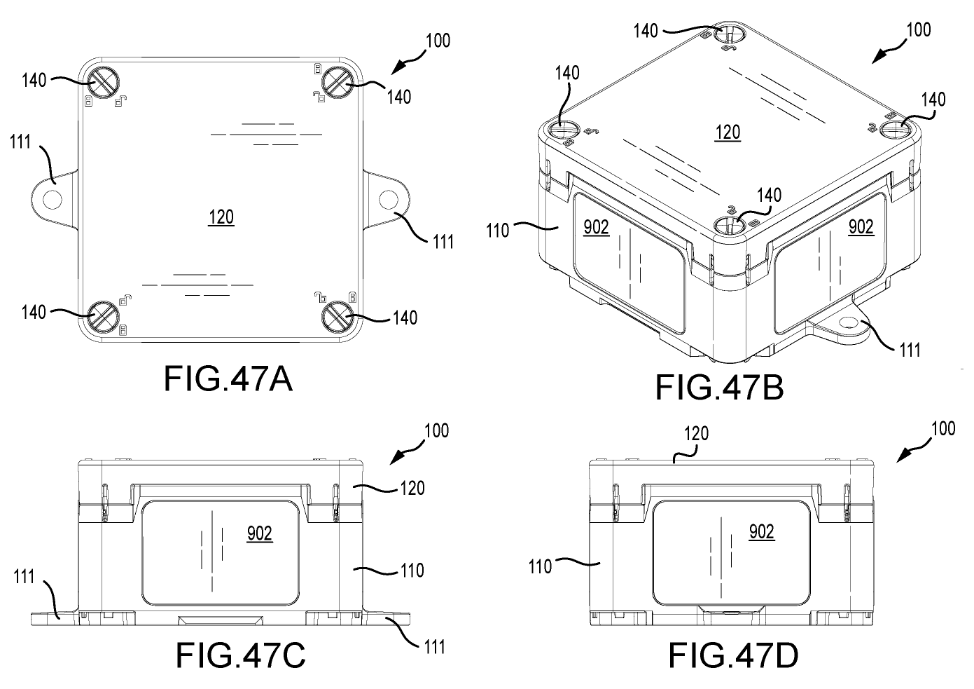

FIGS. 47A, 47B, 47C, and 47D, are top, perspective, and two different side views of an enclosure 100 according to some embodiments. In this example, an enclosure 100 is suitably provided with top 120 that can be initially delivered attached to the bottom of base 110 by any number of fasteners 140 (e.g., four fasteners) as described in connection with FIG. 6 above. Base 110 may be attached to a wall, floor, roof or other mounting surface using mounting hardware and tabs 111, as appropriate. Wires or other electrical components can be housed within the interior of base 110, with access to the interior provided via any number of user-created holes drilled into one or more drill zones 902 on the upright faces of base 110. Drill zones 902 may be molded or otherwise formed to be relatively thin, and/or with consistent thickness across the width and height of the drill zone 902 to facilitate easy drilling across the area of drill zones 902, as well as to facilitate the use of conventional conduit fixtures that would not otherwise be available in thicker-walled (or variable thickness) enclosures.

In some aspects, to close enclosure 100 the installer or other user simply places lid 120 in position along the top edge of base 110 so that one or more fasteners 140 align with one or more channels 145 in base 110. The installer then applies manual force to press fasteners 140 into channels 145. In some aspects, resilient or flexible features in fastener 140, base 110 and/or lid 120 flex as fastener 140 advance into the channel 145, and then snap to retain fastener 140 in place, thereby applying compressive force between lid 120 and base 110. In some aspects, this compressive force can be increased in any number of ways, such as through the use of a gasket 157 and/or other sealing structure, as described herein, to provide a reliable seal (e.g., a watertight seal) that protects the components in the interior of enclosure 100.

In some aspects, to open enclosure 100 the technician/user uses a screwdriver, knife blade or other tool to turn fastener 140 so that the flexible portions of fastener 140 and/or channel 145 become aligned with gaps in the retaining features of the other member, thereby permitting the fastener 140 to be removed from the channel 145 so lid 120 can be separated from base 110. As noted at the outset, various embodiments are therefore able to provide a secure enclosure 100 that is compact, easy to use and provides an effective seal to protect components, while still complying with electrical code provisions that mandate the use of a tool to open the enclosure 100. Some or all of these and other features may be realized from any number of alternate but equivalent embodiments.

Various embodiments of an enclosure have been described. As set forth herein, lid 120 of enclosure 100 can be closed and maintained against the upper walls 116 of the base 110 though simple manual force applied by an installer or other technician. In some aspects, removal of lid 120 may be performed using a screwdriver or other tool, thereby preserving any design or safety standards that specifically require the use of a tool to open enclosure 100. Also, some embodiments permit the lid 120 to be attached without protrusions or other features that extend beyond the circumference of base 110, so that an enclosure 100 can be formed with substantially flat walls in many cases, thereby providing a very spatially efficient box that can fit into tighter spaces that other similarly sized boxes. In some aspects, snap-type fasteners 140 can be designed to be accessed and manipulated from the top of the box, thereby reducing (if not eliminating) the need to access the sides of the box 100. This allows box 100 to be placed flush (or nearly flush) against other objects where boxes needing side access could be placed.

Various changes could be made to the examples set forth herein to create a wide array of alternate but equivalent embodiments. In some aspects, one or more fasteners 140 can be formed as one or more extensions of a lid 120 itself, for example, rather than as separate parts that extend through openings 142 in lid 120. For example, fasteners 140 can be molded as part of lid 120. In this example, fastener 140 will not be a separate component. The various aspects and features described in the different examples herein may be mixed and matched in any manner, and/or any number of modifications could be made.

The concepts set forth herein are often described with respect to enclosures in any setting in which a secure enclosure is desired. Examples could include, without limitation, solar systems, indoor or outdoor electrical enclosures (e.g., weatherproof boxes for wiring and circuit protection), battery enclosures (e.g., secure and removable lids for battery compartments), industrial control boxes (e.g., enclosures for control panels or automation equipment), server & networking racks (e.g., panels or access points that need secure but tool-free entry), toolboxes & storage containers (e.g., locking mechanisms for secure storage), appliance covers (e.g., access panels for HVAC systems or kitchen appliances), laptop docking stations (e.g., securely holding a laptop or electronic device in place), smart home devices (e.g., enclosures for routers, hubs, or smart speakers), vehicle fuse & relay boxes (e.g., protecting automotive or aerospace electrical components), marine & RV electrical enclosures (e.g., waterproof enclosures for boats and campers), bike & motorcycle storage compartments (e.g., keeping compartments closed under vibration and movement), camping & outdoor gear (e.g., locking mechanisms for portable solar battery packs, stoves, or gear cases), medical device casings (e.g., secure yet accessible closures for portable medical equipment), lab equipment enclosures (e.g., containers for sensitive instruments or chemical storage), musical instrument or audio equipment cases, sterile equipment cases (e.g., keeping surgical tools or lab materials secure and contaminant-free), robot access panels (e.g., secure closures for maintenance compartments), heavy machinery control panels (e.g., protective covers that resist dust and vibration), drones & UAV battery compartments (e.g., quick-access closures for changing batteries), fire alarm enclosures (e.g., ensuring access while keeping components protected), lockboxes & safes (e.g., a variation for portable or small-scale safes), and emergency equipment cases (e.g., first aid kits, fire extinguishers, or oxygen tank compartments). Again, equivalent concepts could be used in any sort of enclosure of any size and in any setting.

Several features have been described herein as being “substantially planar”, “substantially perpendicular” or the like. “Substantially” as used in this spatial context is intended to convey that some variations are inherent due to design and manufacturing imperfections, environmental factors and/or the like. Minor variations from perfectly “planar”, “perpendicular”, “parallel” or the like could occur without departing from the general concepts set forth herein. Variations of about 10 percent or so, for example, would not generally affect the performance of the structures described. Indeed, variations of about 25% or so may be permissible in some embodiments, depending upon context.

No claim element herein is to be construed under the provisions of 35 U.S.C. § 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

While several example embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

1. An enclosure comprising:
a base comprising a bottom wall and side walls configured to form an interior region of the enclosure;
a lid; and
a fastening system comprising first fastener associated with the base and second fastener associated with the lid, wherein the fastening system is configured to allow:
the base and lid to be securely coupled together through a snap-fit or push-on manual interaction; and
the base and lid to be separated from each other using a tool that unlocks the first fastener from the second fastener.

2. The enclosure of claim 1, further comprising a drill zone defined in a side wall, the drill zone having a uniform wall thickness.

3. The enclosure of claim 1 wherein:
the second fastener comprises a fastening device that passes through an opening in the lid, and
the first fastener comprises one or more channels configured to receive the second fastener.

4. The enclosure of claim 1, wherein the second fastener comprises a tool interaction point configured to allow a tool to rotate the second fastener such that is moves from a locked to an unlocked position allowing the lid to separate from the base.

5. The enclosure of claim 1, wherein the second fastener comprises a plurality of flexible legs that are configured to be deformable within the first fastener in response to the second fastener being inserted into first fastener.

6. The enclosure of claim 1, further comprising:
a third fastener associated with an opposite end of the base than an end that interacts with the second fastener,
wherein during a first time period, the first fastener is removably attached to the second fastener,
wherein during a second time period the second fastener is removably attached to the third fastener.

7. The enclosure of claim 1, further comprising:
a hinge system configured to be coupled to the lid and the base and to allow a hinging operation between the lid and the base,
wherein the hinge system is coupled to a first portion of the lid and the base, and
wherein the fastening system is coupled to a second, separate portion of the lid and the base.

8. An enclosure comprising:
a base comprising a bottom wall and a plurality of side walls extending substantially perpendicular from the bottom wall to form an interior region of the enclosure, wherein one or more of the side walls has a channel formed therein, the channel having a rigid member;
a lid having a lower surface configured to interact with the side walls of the base; and
a fastener configured to extend from or through the lower surface of the lid into the channel, the fastener comprising a flexible member,
the flexible member configured to flex in response to the fastener being advanced into the channel and to engage the rigid member in response to the fastener being fully advanced in the channel to retain the fastener in the channel and to apply a compressive force between the base and the lid.

9. The enclosure of claim 8, wherein each of the fasteners is rotatable in response to application of a tool so that the flexible member in the channel aligns with and passes through a gap in the rigid member, thereby permitting the fastener to be removed from the channel.

10. The enclosure of claim 8, wherein the flexible member is a pair of flexible legs.

11. The enclosure of claim 8, wherein the lid applies a compressive force to the base in response to engaging the rigid member, and wherein the does not apply a compressive force to the base when installed to the base adjacent the bottom wall.

12. The enclosure of claim 8, further comprising:
a formed-in-place (FIP) gasket disposed at an interface between the side walls of the base and the lower surface of the lid.

13. The enclosure of claim 12, wherein:
at least one of the side walls of the base and the lower surface of the lid comprises a circumferential ridge that is configured to receive the FIP gasket and to apply pressure against the FIP gasket when the compressive force is applied.

14. The enclosure of claim 8, further comprising:
a drill zone located in one or more of the plurality of sidewalls and comprising a thickness that is substantially constant across the drill zone.

15. The enclosure of claim 14, wherein:
the base comprises molded polycarbonate material, and
the substantially constant thickness is between about 0.1 and about 0.2 inches.

16. The enclosure of claim 8, wherein:
the channel extends from a top of the one or more sidewall though a bottom wall of the base and are configured to receive the fastener at the bottom wall of the base to releasably couple the lid to the bottom wall of the base.

17. A method comprising:
inserting a fastener extending from or through a lid into a channel of a base of an enclosure;
flexing a flexible member of the fastener for a predetermined distance within the channel before the flexible member moves back into a static position to allow snapping of the flexible member against a rigid member of the channel;
applying a compressive force between the lid and the base based on the snapping; and
rotating the fastener a predetermine distance to enable releasing of the fastener from the channel.

18. The method of claim 17, further comprising:
receiving a gasket in a circumferential ridge in the lid and/or the base; and
applying pressure against the gasket based on the compressive force.

19. The method of claim 17, wherein:
during a first time period the lid is attached to the top of the base; and
during a second time period the lid is attached to the bottom of the base.

20. The method of claim 17, further comprising:
after the fastener is in the predetermined position, rotating the fastener from a first position to a second position to increase the compressive force between the lid and the base.
